(19) United States
(12) Patent Application Publication
(10) Pub. No.: US 2010/0235835 A1
(43) Pub. Date: Sep. 16, 2010

(54) VIRTUAL MACHINE CONTROL APPARATUS, VIRTUAL MACHINE CONTROL METHOD, AND RECORDING MEDIUM THEREFOR

(75) Inventors: Naoki NISHIGUCHI, Kawasaki (JP); Noboru Iwamatsu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/719,428

(22) Filed: Mar. 8, 2010

(30) Foreign Application Priority Data
Mar. 10, 2009 (JP) 2009-057061

(51) Int. Cl. G06F 9/455

(52) U.S. Cl. 718/1

(57) ABSTRACT

A virtual machine control apparatus that controls operations of a plurality of virtual machines, the virtual machine control apparatus includes a storing part that stores information in a memory used by an application program in a storage unit different from the memory, in association with a virtual machine subject to a suspending command, when the suspending command for the virtual machine in operation; and a selecting part that selects an application program to be preferentially resumed from the storage unit to the memory use area based on the information in the memory used by the application program which is stored in association with the virtual machine subject to the activating command, when the activating command for the virtual machine is accepted.

### CROSS-REFERENCE TO RELATED APPLICATIONS

This application is based upon and claims the benefit of priority of the prior Japanese Patent Application No. 2009-57061, filed on Mar. 10, 2009, the entire contents of which are incorporated herein by reference.

### FIELD

The embodiments discussed herein are related to an apparatus for controlling a plurality of virtual machines operating on a computer, a control method, and a recording medium therefor.

### BACKGROUND

In recent years, a computer for virtually controlling a plurality of virtual machines has been widely used. The computer for virtually controlling the virtual machines also has a suspending function similarly as in a personal computer (for example, see Japanese Laid-open Patent Publication No. 2004-362426). At the time of suspending the virtual machine, information in a memory used by the relevant virtual machine is set aside to a hard disk or the like. Then, at the time of activating, this information thus set aside is resumed in the memory.

### SUMMARY

According to an aspect of the invention, a virtual machine control apparatus that controls operations of a plurality of virtual machines includes a storing part that stores information in a memory used by an application program in a storage unit different from the memory, in association with a virtual machine subject to a suspending command, when the suspending command for the virtual machine in operation, and a selecting part that selects an application program to be preferentially resumed from among the application programs stored in the storage unit to the memory use area based on the information in the memory used by the application program which is stored in association with the virtual machine subject to the activating command, when the activating command for the virtual machine is accepted.

The object and advantages of the embodiment discussed herein will be realized and attained by means of elements and combinations particularly pointed out in the claims.

It is to be understood that both the foregoing general description and the following detailed and the following detailed description are exemplary and only are not restrictive exemplary explanatory are not restrictive of the invention, as claimed.

### BRIEF DESCRIPTION OF DRAWINGS

FIG. 1 is an explanatory diagram depicting an example of an outline of a control system;

FIG. 2 is a block diagram depicting an example of hardware and software of a physical machine and a VM (virtual machine);

FIG. 3 is an explanatory diagram representing an example of a record layout of a saving file;

FIG. 4 is an explanatory diagram representing an example of a record layout of a VM (virtual machine) managing unit;

FIG. 5 is an explanatory diagram representing an example of a record layout of a hardware information file;

FIG. 6 is an explanatory diagram schematically depicting an example of a content of a RAM;

FIG. 7 is an explanatory diagram representing an example of a record layout of an area file;

FIG. 8 is an explanatory diagram representing an example of an image of a selecting screen;

FIG. 9 is an explanatory diagram representing an example of a record layout of a page table;

FIGS. 10A to 10D are explanatory diagrams schematically representing examples of transitions of resuming processing;

FIG. 11 is an operation chart representing an example of a procedure of suspending processing;

FIG. 12 is an operation chart representing an example of a procedure of the suspending processing;

FIG. 13 is an operation chart representing an example of a procedure of generation processing for the area file;

FIG. 14 is an operation chart representing an example of a procedure of the resuming processing;

FIG. 15 is an operation chart representing an example of a procedure of the resuming processing;

FIG. 16 is an operation chart representing an example of a procedure of the resuming processing;

FIG. 17 is an operation chart representing an example of a procedure of page fault processing;

FIG. 18 is an operation chart representing an example of a procedure of the page fault processing;

FIG. 19 is a block diagram depicting an example of hardware and software of the physical machine and the VM (virtual machine) according to Embodiment 2;

FIG. 20 is an explanatory diagram representing an example of a record layout of a history file;

FIG. 21 is an explanatory diagram representing an example of a record layout of the area file according to Embodiment 2;

FIG. 22 is an operation chart representing an example of a procedure of the suspending processing;

FIG. 23 is an operation chart representing an example of a procedure of the suspending processing;

FIG. 24 is an operation chart representing an example of a procedure when an input of identification information is accepted before the suspending processing;

FIG. 25 is an operation chart representing an example of a procedure when the input of the identification information is accepted before the suspending processing;

FIG. 26 is an operation chart representing an example of a procedure of selection processing;

FIG. 27 is an explanatory diagram representing an example of a screen image displayed on a display unit of a computer;

FIG. 28 is an explanatory diagram representing an example of a record layout of the history file;

FIG. 29 is an operation chart representing an example of a procedure of obtaining processing for time information and selection information;

FIG. 30 is an operation chart representing an example of a procedure of the obtaining processing for the time information and the selection information;

FIG. 31 is an operation chart representing an example of a procedure of the selection processing;

FIG. 32 is an operation chart representing an example of a procedure of the selection processing;

FIG. 33 is an operation chart representing an example of a procedure of the selection processing;

FIG. 34 is a block diagram depicting an example of hardware and software of the physical machine and the VM (virtual machine);

FIG. 35 is an operation chart representing an example of a procedure of selection processing based on a priority;

FIG. 36 is an operation chart representing an example of a procedure of the selection processing based on the priority;

FIG. 37 is an operation chart representing an example of a procedure of the selection processing based on the priority;

FIG. 38 is an explanatory diagram representing an example of an image of the selecting screen;

FIG. 39 is an operation chart representing an example of a procedure of assigning the priority;

FIG. 40 is an operation chart representing an example of a procedure of assigning the priority;

FIG. 41 is an operation chart representing an example of a procedure of priority calculation processing according to Embodiment 9;

FIG. 42 is an explanatory diagram representing an example of a record layout of the history file according to Embodiment 10;

FIG. 43 is an operation chart representing an example of a procedure of the priority calculation processing according to Embodiment 10;

FIG. 44 is an operation chart representing an example of the priority calculation processing according to Embodiment 10;

FIG. 45 is a block diagram depicting an example of hardware and software of the physical machine and the VM (virtual machine) according to Embodiment 11;

FIG. 46 is an operation chart representing an example of a procedure of correction processing;

FIG. 47 is an explanatory diagram representing an example of a record layout of the history file according to Embodiment 12;

FIG. 48 is an operation chart representing an example of a procedure of the priority calculation processing according to Embodiment 12;

FIG. 49 is an operation chart representing an example of a procedure of the priority calculation processing according to Embodiment 12;

FIG. 50 is a block diagram depicting an example of hardware and software of the physical machine and the VM (virtual machine) according to Embodiment 13.

### DESCRIPTION OF EMBODIMENTS

When information stored in a hard disk or the like is resumed at the time of being activated, the resuming takes much time, and a user who desires speedy usage is inconvenienced.

An object of the present invention is to provide an apparatus and a method and the like for selecting an application program to be preferentially resumed, and to allow users to use a desired application program promptly when reactivation is carried out after a suspended state.

According to the present embodiment, as information of the selected application program is resumed in a use area of the memory in order from among a storage unit in which application programs are stored, it is possible to utilize the desired application program more promptly.

### Embodiment 1

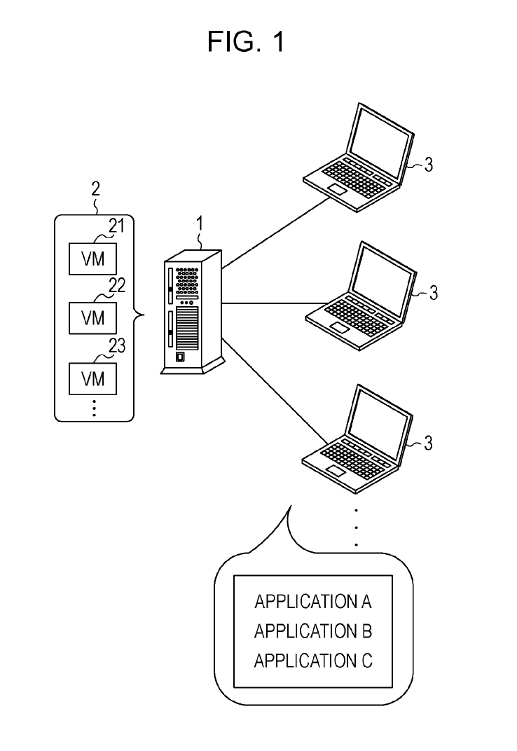

Hereinafter, embodiments will be described with reference to the drawings. FIG. 1 is an explanatory diagram depicting an example of an outline of a control system. The control system includes a physical machine 1, a virtual machine 2, and terminal apparatuses 3, 3, 3 . . . . The physical machine 1 may be, for example, a server computer and may control a plurality of virtual machines (hereinafter referred to as VM (Virtual Machine)) 21, 22, 23, . . . (hereinafter represented by 2 in some cases).

The terminal apparatus 3 may be, for example, a personal computer, an input and output apparatus having a communication function, an input and output apparatus, and a monitor, or the like. Hereinafter, the terminal apparatus 3 may be a personal computer (hereinafter referred to as a computer 3).

The computer 3 and the physical machine 1 are connected to each other via a communication network such as the internet or a LAN (Local Area Network) and send and receive information based on a given protocol. According to the present embodiment, the description will be provided while giving an example in which the computer 3 is connected to the physical machine 1 by a LAN. A user using the computer 3 activates the VM 2 via the physical machine 1. The plurality of VMs 21, 22, and 23, . . . are operating on the physical machine 1. Hereinafter, the description will be provided while giving an example in which the VM 2 made up of at least one VM 2n, where n is an integer not less than 1. The following embodiments will use VM21, VM22, and VM23 as examples, however, the embodiments are not limited as such.

An outline of the present embodiment will be described. When the VM 21 in operation accepts a suspending command, the physical machine 1 suspends the VM 21. In this case, information in the memory used by the VM 21 is saved (hereinafter may be referred to as “stored” in some cases) in another storage unit such as a hard disk. When the VM 21 is activated, a list of application programs (hereinafter referred to as “applications”) used at the time of the suspending is displayed. In the example of FIG. 1, three applications including an application A, an application B, and an application C are displayed. The user selects an application desired to be preferentially resumed. The physical machine 1 preferentially resumes information related to the selected application from the storage unit to the memory.

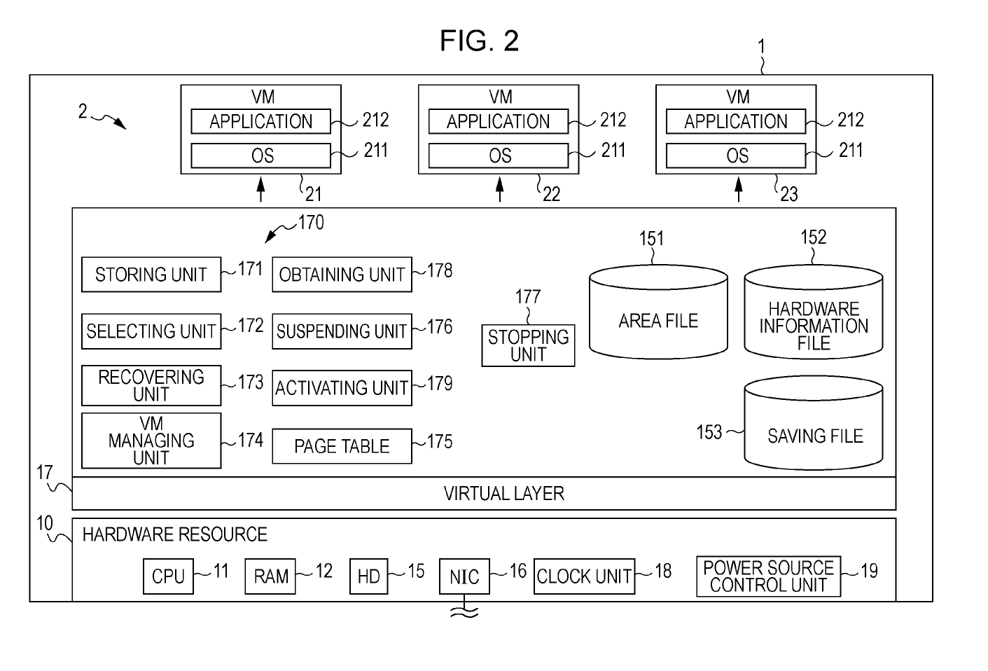

FIG. 2 is a block diagram depicting an example of hardware and software of the physical machine 1 and the VM 2. The physical machine 1 includes a hardware resource 10 and a virtual layer 17. The hardware resource 10 is provided with a CPU (Central Processing Unit) 11, a RAM (Random Access Memory) 12, a storage unit (HD) 15, an NIC (Network Interface Card) 16, a clock unit 18, a power source control unit 19, and the like. The hardware resource 10 is placed under control of a virtual layer functioning as virtual software. The CPU 11 follows instructions from the virtual layer and a control module 170 on the virtual layer and controls the hardware connected via a bus (not shown).

The RAM 12 functioning as a memory may be, for example, an SRAM (Static RAM), a DRAM (Dynamic RAM), a flash memory, or the like. The RAM 12 temporarily stores various pieces of data generated when the CPU 11 executes various programs of, for example, the virtual layer. For another storage unit different from the RAM 12, for example, a hard disk or a large-capacity memory may be utilized. According to the present embodiment, the description will be provided while the other storage unit is the hard disk, which will be hereinafter referred to as HD 15. The HD 15 stores a file created by the VM 2, various pieces of data that are stored due to an instruction from the virtual layer, and the like. The NIC 16 is an Ethernet card or the like and is used to send and receive information to and from the computer 3, another Web server (not shown), or the like based on HTTP (HyperText Transfer Protocol) etc. The clock unit 18 outputs time information to the CPU 11.

The control module 170 operating in collaboration with the virtual layer performs various processes including suspending processing or stop processing for the VMs 21, 22, and 23, and power source management processing for the physical machine 1. The control module 170 includes a storing unit 171, a selecting unit 172, a resuming unit 173, a suspending unit 176, a stopping unit 177, an activating unit 179, an obtaining unit 178, a VM managing unit 174, and the like, and is executed while being loaded onto the RAM 12. In the RAM 12 or the HD 15, a page table 175, an area file 151, a hardware information file 152, and the like are prepared. According to the present embodiment, the description will be provided while giving an example of using hypervisor type virtual software in which the virtual layer is directly operating on the hardware resource 10, but the configuration is not limited to the above. A host type may also be used where the virtual software is operating on Windows (registered trademark) or Linux (registered trademark).

The user desiring to activate the physical machine 1 in a stop state and utilize the VM 21 uses the computer 3 to activate the physical machine 1. The computer 3 outputs an activating command to the physical machine 1. Also, the computer 3 outputs identification information (hereinafter referred to as “VM-ID”) for identifying the VM desired to be activated among the plurality of VMs 2 and the activating command for the VM 2 to the physical machine 1. According to the present embodiment, the description will be provided while giving an example in which the VM 21 is activated. The NIC 16 corresponds to Wake On Lan function, and in response to the activating command for the physical machine 1, an activating command is output to the power source control unit 19. The computer 3 outputs a magic packet for turning ON a power source for the physical machine 1 to the NIC 16.

The power source control unit 19 supplies electric power from an AC power source (not shown) to the physical machine 1. According to this, the physical machine 1 is activated, and the virtual layer and the control module 170 are also activated. The activating unit 179 activates the VM 21. The VM 21 operates under control of the virtual layer. An OS (Operating System) 211 installed in the VM 21 executes the various applications A, B, C . . . (hereinafter, a specific application may be represented by 212 in some cases). The application 212 may be, for example, a document creating application, a browser, a table calculation document creating application, a mailer, or a presentation document creating application, etc. The VM 21 outputs screen information via the NIC 16 to the computer 3. Similarly, another user may utilize the VM 22 by using another computer 3. In this case, the other computer 3 outputs the VM-ID of the VM 22 and the activating command for the VM 22 to the physical machine 1. In response to this, the activating unit 179 activates the VM 22. Unique user identification information for identifying users may be assigned, and a plurality of users may share one VM 21.

When a suspending command for the VM 21 is output from the computer 3, the suspending unit 176 accepts the suspending command and suspends the VM 21. The suspending unit 176 saves hardware information stored in the RAM 12 including context information and device information of the VM 21 in the hardware information file 152. Also, the suspending unit 176 outputs a suspending command to the storing unit 171. The storing unit 171 saves information on the RAM 12 used when the VM 21 receives the suspending command in a saving file 153 in the HD 15.

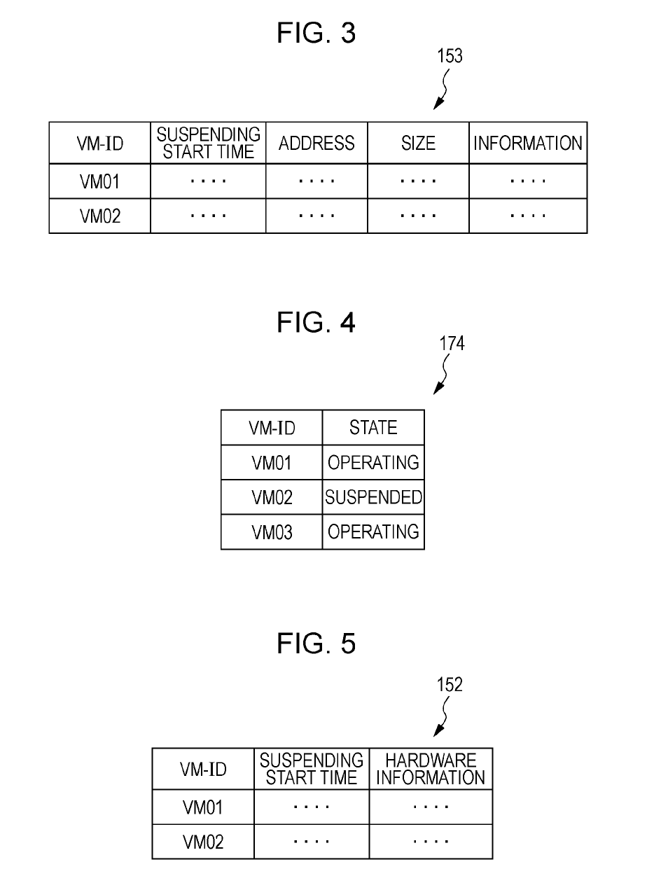

FIG. 3 is an explanatory diagram representing an example of a record layout of the saving file 153. The saving file 153 includes a VM-ID field, a suspending start time field, an address field, a size field, and an information field. The VM-ID field stores the VM-ID for the VM 2 accepting the suspending command. The suspending start time field stores a time output from the clock unit 18 when the VM 2 is suspended (hereinafter referred to as “suspending start time”) in association with the VM-ID. The address field stores an address of the RAM 12 used by the VM 2 accepting the suspending command in association with the VM-ID.

The size field stores a size of the RAM 12 used by the VM 2 accepting the suspending command, and the information field stores information of the RAM 12 used by the VM 2 accepting the suspending command. When the storing unit 171 accepts the suspending command, the target VM-ID and the time output from the clock unit 18 are stored in the saving file 153 as the suspending start time. Also, the storing unit 171 stores the address, the size, and the information of the RAM 12 used by the VM 2 accepting the suspending command, in the saving file 153 in association with the VM-ID.

The area of the RAM 12 used by the VM 21 is released after the suspending. When a stopping command for the VM 21 is sent from the computer 3, the stopping unit 177 accepts the stopping command and stops the VM 21. To be more specific, the OS 211 and the application 212 used by the VM 21 are ended, the information in the area of the RAM 12 is released instead of being stored in the HD 15, and the operation of the VM 21 is shut down.

FIG. 4 is an explanatory diagram representing an example of a record layout of the VM managing unit 174. The VM managing unit 174 stores states of the VM 2 including operating, suspended, and stopped in association with the VM-ID. In the example of FIG. 4, it is indicated that that the VM 21 whose VM-ID is “VM01” is in the operating state and the VM 22 whose VM-ID is “VM02” is in the suspended state. The VM managing unit 174 monitors the state of the VM 21. When the state of the VM 21 has changed, the VM managing unit 174 stores the changed state in association with the VM-ID of the VM 21.

FIG. 5 is an explanatory diagram representing an example of a record layout of the hardware information file 152. The hardware information file 152 includes the VM-ID field, the suspending start time field, and a hardware information field. The suspending start time field stores the time information output from the clock unit 18 (suspending start time) when the suspending unit 176 suspends the VM 2, in association with the VM-ID.

The hardware information field stores, in association with the VM-ID, information to allow hardware such as the CPU 11 and the RAM 12 to be resumed to the same state as at the time when the VM2 was suspended. To be more specific, the hardware information corresponds to the context information such as register information of the CPU 11, the device information such as an I/O register value of each of hardware and an access mode of the HD 15, and the like. When the VM 2 is suspended, the suspending unit 176 reads out the hardware information on the suspended VM 2 stored in the RAM 12 and stores the hardware information in the hardware information file 152 in association with the VM-ID. In addition, at the time of the suspended state or when the suspending command is accepted, the suspending unit 176 stores the time output from the clock unit 18 as the suspending start time.

The activating unit 179 accepts an activating command for the suspended VM 21 from the computer 3. The activating command includes the VM-ID, and the activating unit 179 activates the VM 21 corresponding to the VM-ID. The activating unit 179 outputs the activating command to the selecting unit 172, the resuming unit 173, and the obtaining unit 178. When the information on the RAM 12 at the time of the suspended state which is stored in the saving file 153 is resumed, the resuming unit 173 resumes the application 212 preferentially selected by the selecting unit 172.

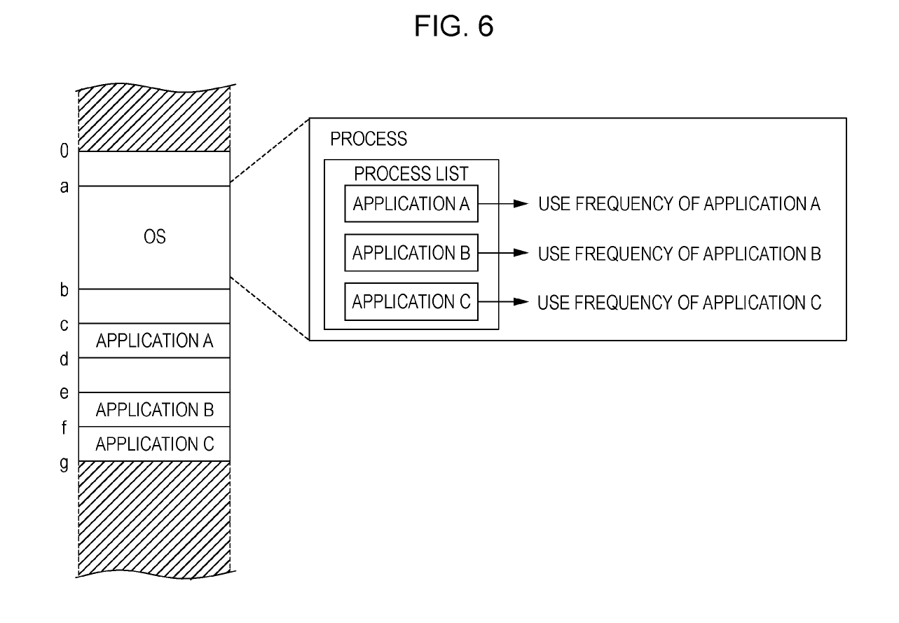

The obtaining unit 178 refers to the VM-ID of the VM to be activated and reads out the information of the RAM 12 at the time of the suspended state which is stored in the saving file 153. FIG. 6 is an explanatory diagram schematically depicting an example of a content of the RAM 12. 0, a, b . . . , and g in FIG. 6 denote virtual addresses in the RAM 12 used by the VM 21 at the time of the suspended state. A virtual address and a physical address exist for an address, but for facilitating the explanation, the description will be provided while giving an example of the virtual address. The virtual address and the physical address are stored in association with each other in the page table 175 which will be described below. The virtual address herein refers to the physical address in the VM 2, and the OS 211 of the VM 2 treats the virtual address as the physical address. In order to convert the virtual address into the actual physical address, the page table 175 is used.

The VM 21 uses areas at virtual addresses between 0 and g. The virtual address a to b is, for example, for the area of the OS 211, and the OS 211 including a code of the application 212 is stored. According to the present embodiment, the description will be provided while three suspended applications, application A, the application B, and application C, are activated. In addition to a case in which the application A and the application B are different types of applications 212 such as the document creating application and the browser, a case is also included in which the application A and the application B are the same application but used files are different from each other.

The virtual address c to d is for a use area of the application A, the virtual address e to f is for a use area of application B, and the virtual address f to g is for a use area of the application C. The OS 211 stores information on the applications A to C and the use areas of the RAM 12 used by the respective applications A to C. The obtaining unit 178 analyzes the inside of the OS 211 to identify the respective application 212 used at the time of the suspending, and also obtains the use areas of the RAM 12 used by the respective applications 212. To be more specific, the obtaining unit 178 identifies an address of variables (hereinafter referred to as “process list”) for accessing the information on the respective applications 212. In this case, the obtaining unit 178 identifies the address of the process list from information in which a symbol (function name or variable name) created when compiling the OS 211 and an address are set as a pair. In addition, the commands may be analyzed sequentially from the heading of the virtual address of the OS 211 to identify the address of the process list. An example of a specific identification method will be depicted. In Linux (registered trademark), when compiling the OS 211 (i.e., a kernel: software in which a basis function of the OS is mounted), a file “System.map” indicating at which address the symbol (function name or variable name) is expanded at the time of execution is also created in addition to an execution file. In Linux (registered trademark), “process list address” is a structure of a variable name “init_task”. For example, in a certain environment, “init_task” is described as “ffffffff802e5ae0 D inittask” in “System.map”. For example, at the time of the execution, “inittask” is arranged at an address “0xffffffff802e5ae0”. By referring to this address to track all the processes connected to “init_task” as the list, it is possible to obtain the structures for all the processes. In addition, a case in which “System.map” does not exist will be described. In this case, as the location at which the OS 211 (kernel) is arranged has not changed, a processing after booting of the kernel is analyzed from a machine language to identify a position where “init_task” is used. This may be executed by previously learning which processing is performed by the kernel.

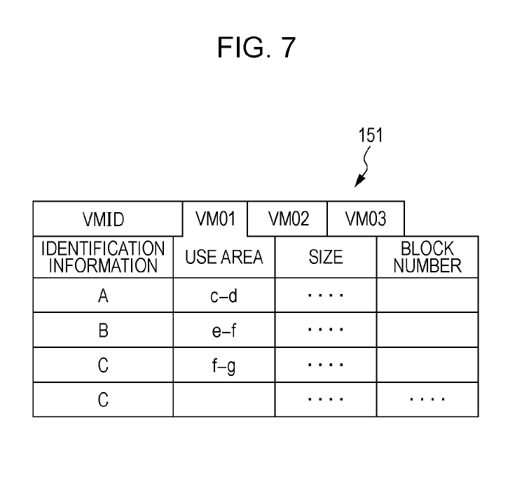

Thereafter, the obtaining unit 178 refers to the address of the process list to search the inside of the structure existing in the OS 211 and identifies the structures of the respective applications 212. The obtaining unit 178 analyzes the inside of the structure of the identified application 212 and obtains the use areas of the respective applications 212. The obtaining unit 178 stores the obtained use areas of the applications 212 and the like in the area file 151. FIG. 7 is an explanatory diagram representing an example of a record layout of the area file 151. The area file 151 stores the information related to the use areas of the respective applications 212 for each VM-ID (Virtual Machine Identification). The area file 151 includes an identification information field, a use area field, the size field, and a block number field.

The identification information field stores unique identification information for identifying the application 212 executed at the time of the suspended state. This identification information includes the application name, the unique ID assigned to the application 212, the application name and the file name of the relevant application 212, a path, a folder name, a browser name, a Web page name, a mailer and tray name, a mailer and mail title, and the like. For example, in the case of the document creating application, the application name and the file name of the document are stored as the identification information. Also, in the case of the application 212 for displaying the inside of a folder such as Explorer (copyright of Microsoft Corporation), the folder name, the path, or the like may be stored as the identification information.

When the application 212 is a browser, the browser name and the Web page name for identifying the Web page or URL (Uniform Resource Locator) displayed at the time of the suspending are stored as the identification information. Also, when the application 212 is a mailer, a type of the mailer and the tray name, the mail folder, or the like are stored as the identification information. According to the present embodiment, for facilitating the explanation, the description is provided in which the application A is the document creating application and the file name is “Document A”, and the application B is also the document creating application and the file name is “Document B”. Also, the description is provided in which the application C is the presentation application and the file name is “slide C”.

The use area field stores the use area in association with the identification information on the application 212. For example, the use area of the application A is stored as the virtual address between c and d. The size field stores a size of the use area used by the respective applications 212. According to the present embodiment, the identification information and the use area are represented as the examples for the information related to the use area, but the configuration is not limited to the above. For example, for the information related to the use area, the identification information and heading virtual addresses and sizes of the respective applications 212 may be stored. In this case, from the heading virtual addresses and the sizes, the use areas corresponding to the respective pieces of identification information are calculated. The block number field stores an address at a swap destination to the HD 15 (swap: a function of the OS for increasing the usable memory capacity. This operation is as follows: a dedicated area called a “swap file” is prepared on the hard disk. When the memory capacity becomes insufficient, a content of a memory area which is not in use is temporarily set aside to the hard disk [swap-out] and written back to the memory when necessary [swap-in]). When the information in the RAM 12 used by the application 212 at the time of the suspending is swapped to the HD 15, the number at the swap destination is stored. In the example of FIG. 7, the number at the swap destination regarding the application C is stored. When the block number exists, as the address at which the area is swapped in by the OS 211 is not decided (swap-in: in a virtual memory technology for dealing with a hard disk as a part of a memory, a content temporarily set aside on the hard disk in order to make a capacity of a physical memory available is written back to the memory), the use area is invalid. Also, as the swap-in is performed by the OS 211, the block number is used for previously reading the information that is swapped in from the HD 15. That is, it is an object to shorten the read time from the HD 15 by reading into the memory as a cache at the time of the swap-in processing by the OS 211.

The obtaining unit 178 identifies the application 212 from the OS 211 as described above and extracts the application name and the file name by analyzing the structure within the OS 211 with respect to the identified application 212. The obtaining unit 178 stores the extracted application name and file name of the application 212 in the area file 151 as the identification information. Also, the obtaining unit 178 analyzes the OS 211 and obtains the use area of the application 212 to be stored in the area file 151. Also, the obtaining unit 178 analyzes the OS 211 and stores, when it is determined that the information on the application 212 is swapped into the HD 15, the block number at the swap destination in the area file 151.

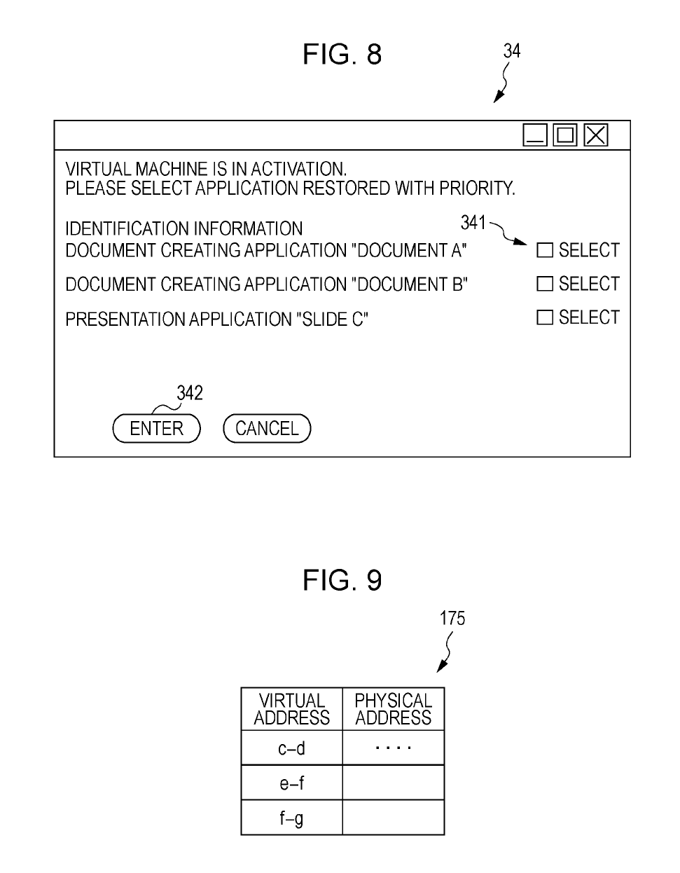

The selecting unit 172 refers to the area file 151 to read out a selecting screen for selecting the identification information on the application 212 from the HD 15. The selecting unit 172 outputs the selecting screen to the computer 3. FIG. 8 is an explanatory diagram representing an example of an image of the selecting screen. The selecting unit 172 reads out the identification corresponding to the VM-ID which is the activating target, from the area file 151. The selecting unit 172 describes the read out the identification information on a basic selecting screen which is a template to generate a selecting screen 34. As represented in FIG. 8, on the selecting screen 34, pieces of the identification information on the application 212 are displayed, and selection items corresponding to the identification information are displayed. Hereinafter, the selection items corresponding to the identification information are referred to as a check box 341. The user clicks the check box 341 corresponding to the identification information on the application 212 desired to be preferentially resumed by a mouse of the computer 3 or the like and clicks an enter button 342. When the selection item corresponding to the identification information is output, instead of the check box 341, a hyper link (not shown) may be output as the selection item. In this case, the selecting unit 172 describes the hyper link to which the information for identifying the identification information is added in association with the identification information. The selecting unit 172 accepts an input operation with respect to the relevant hyper link from the computer 3.

The identification information selected by the computer 3 is accepted via the NIC 16 by the selecting unit 172. The selecting unit 172 outputs the selected identification information to the resuming unit 173. According to the present embodiment, the description is provided while it is supposed that the document creating application “Document A” (application A) is selected. The resuming unit 173 performs an allocation of the RAM 12 used by the VM 21. Then, the resuming unit 173 reads out the hardware information corresponding to the VM-ID stored in the hardware information file 152. The resuming unit 173 resumes the hardware information read out into the RAM 12. Furthermore, the resuming unit 173 resumes the OS 211 obtained by the obtaining unit 178 in an allocated area of the RAM 12.

The resuming unit 173 subsequently resumes information on “Document A” in the use area on the RAM 12 identified based on the information related to the use area stored in the area file 151. The resuming unit 173 reads out the use area corresponding to the selected identification information “Document A” from the area file 151. Based on the read out use area, the resuming unit 173 reads out information for resuming the application A from the saving file 153. Then, the resuming unit 173 resumes the read out information in the read out user area on the RAM 12. FIG. 9 is an explanatory diagram representing an example of a record layout of the page table 175. The resuming unit 173 stores a corresponding relation between a virtual address and a physical address in the page table 175. At the time of resuming, the resuming unit 173 stores the physical address of the RAM 12 which is the resuming destination in the page table 175 in association with the virtual address. When an operation command for the application A is accepted from the computer 3, the physical address corresponding to the virtual address preferentially resumed is read out from the page table 175, and the processing is executed.

After resuming of the application A to be preferentially resumed, the resuming unit 173 similarly performs the resuming of the other applications B and C. The above-mentioned record layouts of the various files are merely examples, and the configurations are not limited to the above. If the association between the data is secured, another method of holding the data may also be adopted. Also, the saving file 153 or the like may not be stored in the HD 15 in the physical machine 1. The saving file 153 or the like may be stored in a database (not shown) connected via the NIC 16 and writing and reading of appropriate information may be carried out. Also, according to the present embodiment, the example of selecting only “Document A” has been described, but the configuration is not limited to the above. The selecting unit 172 may accept identification information together with selection orders from the computer 3. In this case, the resuming unit 173 resumes the application 212 having the preferentially high selection order among the selected applications 212, 212, . . . . For example, it is supposed that the identification information “Document A” has the selection order “1”, and the identification information “Document B” has the selection order “2”. The selecting unit 172 accepts the identification information and combinations of the selection orders from the computer 3. The resuming unit 173 refers to the selection orders and resumes the application 212 related to the identification information “Document A” first. After the resuming of “Document A”, the resuming unit 173 resumes the application 212 related to the identification information “Document B” while following the selection order.

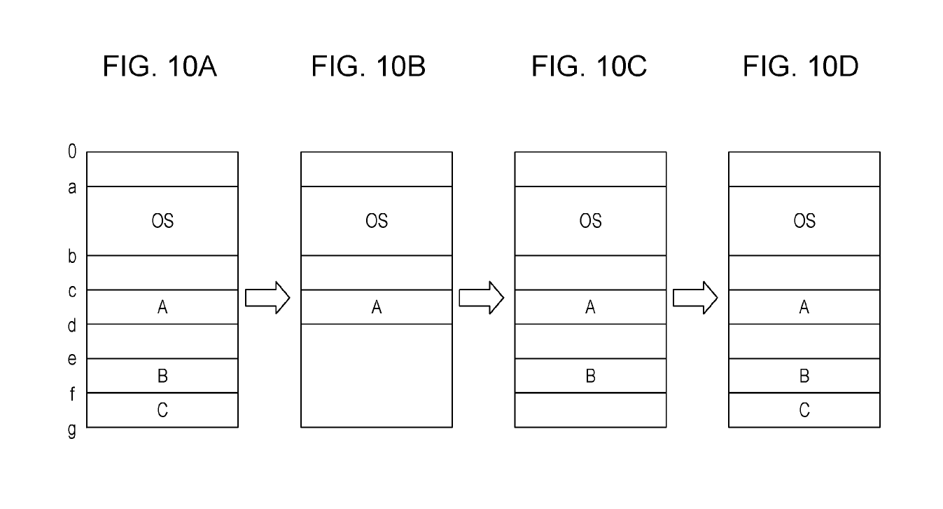

FIGS. 10A to 10D are explanatory diagrams schematically representing examples of transitions of the resuming processing. FIG. 10A is an explanatory diagram representing an example of the state of the RAM 12 at the time of suspending. At the time of suspending, the application A, the application B, and the application C respectively use the RAM 12. FIG. 10B is an explanatory diagram representing an example of the state of the RAM 12 when the application A is preferentially resumed. Information in the use area c to d of the selected application A is resumed. FIG. 10C is an explanatory diagram representing an example of the state in which the application B is resumed after the application A is preferentially resumed. Following the application A, the application B is resumed in the use area e to f.

FIG. 10D is an explanatory diagram representing an example of the state of the RAM 12 when the resuming is completed. Information in the application C is lastly resumed in the use area f to g. As represented in FIG. 10B, when the resuming of the application B and the application C is not completed, the resuming unit 173 generates a page fault and resumes the corresponding information from the HD 15 in the RAM 12. To be more specific, when the access to the virtual address is received from the computer 3, the resuming unit 173 refers to the corresponding physical address of the page table 175. At this time, when the resuming unit 173 determines that the physical address does not exist, the information corresponding to the use area of the area file 151 is read out from the saving file 153. Then, the resuming unit 173 resumes the read out information in the RAM 12.

For example, when the operation command for the use area f to g of the application C is accepted, among the information stored in the saving file 153 in the HD 15, the information corresponding to the user area f to g is read out and resumed in the RAM 12. The above-mentioned processing executed by the control module 170 such as the storing unit 171 is performed by the CPU 11.

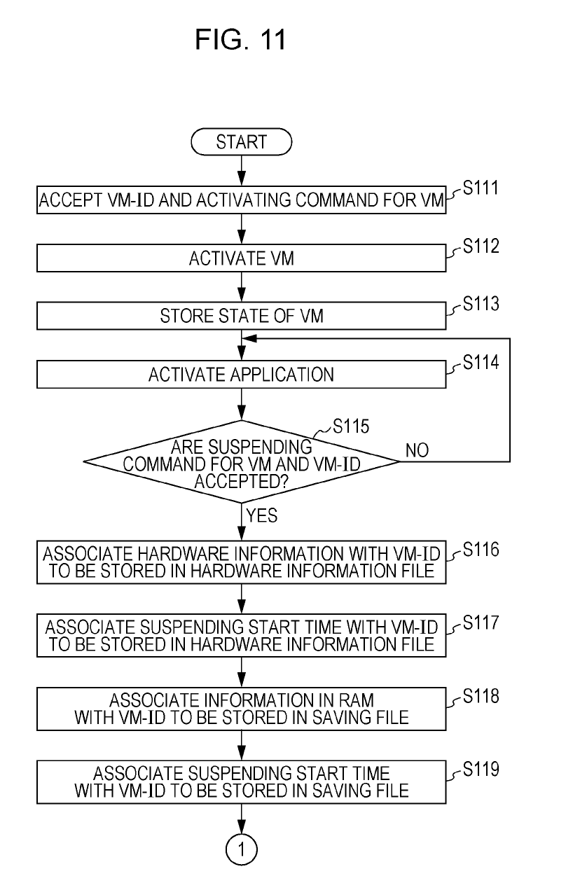

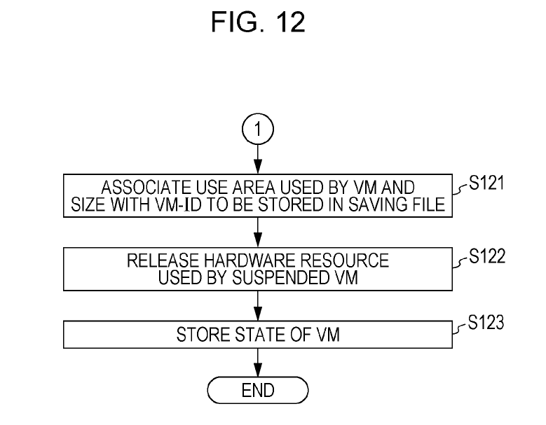

FIGS. 11 and 12 are operation charts representing examples of a procedure of suspending processing. The user specifies the VM 2 desired to use after the activation of the physical machine 1 by using the computer 3. The computer 3 outputs the VM-ID and the activating command for the VM 2 to the physical machine 1. The activating unit 179 of the physical machine 1 accepts the VM-ID and an activating command for the VM 2 via the NIC 16 (at operation S111). The activating unit 179 activates the VM 2 (at operation S112). On the VM 2, the OS 211 is activated. The VM managing unit 174 stores the state “operating” in association with the VM-ID (at operation S113). Also, when the activating command for the application 212 is accepted from the computer 3, the OS 211 on the VM 2 activates the application 212 (at operation S114). In the present example, the description is provided while it is supposed that the plurality of applications A, B, and C are activated.

When the suspending of the VM 2 is desired, the user inputs the suspending command from the computer 3. The computer 3 outputs the suspending command for the VM 2 and the target VM-ID. The suspending unit 176 determines whether or not the suspending command for the VM 2 and the VM-ID are accepted via the NIC 16 from the computer 3 (at operation S115). When the suspending unit 176 determines that the suspending command of the VM-ID is not accepted (at operation S115: NO), the processing returns to operation S114. On the other hand, when the suspending unit 176 determines that the suspending command for the VM 2 and the VM-ID are accepted (at operation S115: YES), the suspending command is output to the storing unit 171. Herein, the output example of the suspending command to the suspend unit 176 is described, but in the computer 3, the suspending command may also be issued to the OS 211 on the VM 2. At that time, the suspending command is output from the OS 211 to the suspending unit 176.

The storing unit 171 stores the hardware information related to the VM 2 which is the suspending target in the RAM 12 in the hardware information file 152 in association with the VM-ID (at operation S116). In this case, the storing unit 171 stores the time output from the clock unit 18 as the suspending start time in the hardware information file 152 in association with the VM-ID (at operation S117). The storing unit 171 stores the information in the RAM 12 used by the suspending target VM 2 in the saving file 153 in association with the VM-ID (at operation S118).

The storing unit 171 stores the time output from the clock unit 18 as the suspending start time in the saving file 153 in association with the VM-ID (at operation S119). In addition, the storing unit 171 stores the use area (address) and the size of the RAM 12 used by the suspending target VM 2 in the saving file 153 in association with the VM-ID (at operation S121). When the processing in operation S121 is completed, the storing unit 171 outputs the completion information to the suspend unit 176. When the suspend unit 176 receives the completion information, the hardware resource 10 such as the RAM 12 used by the suspended target VM 2 is released (at operation S122). The VM managing unit 174 stores the state “suspended” in association with the VM-ID (at operation S123).

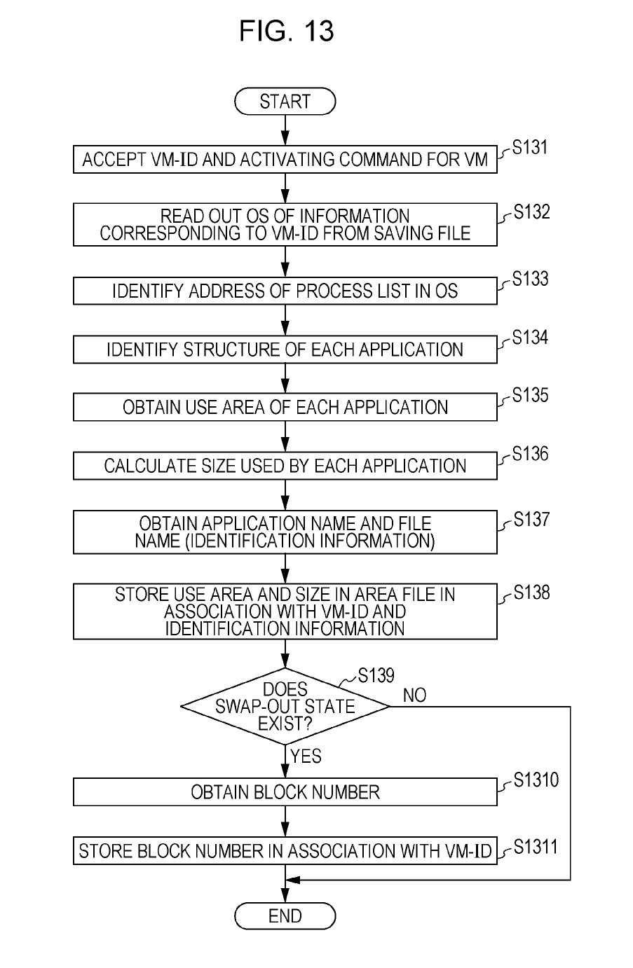

FIG. 13 is an operation chart representing an example of a procedure of generation processing for the area file 151. The user who desires the activation of the VM 2 in the suspended state outputs the activating command and the activating target VM-ID from the computer 3. Instead of outputting the VM-ID from the computer 3, a MAC address (Media Access Control address) of the hardware of the computer 3 may be output to the physical machine 1. In this case, as the physical machine 1 associates the MAC address with the VM-ID, it is possible to activate the VM 2 corresponding to the VM-ID. Also, as long as the VM 2 may be identified, a user ID, a computer name, or the like may be adopted.

The activating unit 179 accepts the VM-ID and the activating command for the VM 2 via the NIC 16 (at operation S131). The activating unit 179 outputs the activating command to the obtaining unit 178. The obtaining unit 178 analyzes the inside of the OS 211 to identify the respective applications 212 used at the time of the suspending and also obtains the use areas of the RAM 12 used by the respective applications 212. The obtaining unit 178 first refers to the VM-ID to read out the OS 211 among the information on the corresponding VM 2 from the saving file 153 (at operation S132). The obtaining unit 178 identifies the address of the process list which is a variable for accessing the respective applications 212 in the OS 211 (at operation S133).

The obtaining unit 178 refers to the obtained address of the process list to search the inside of the structure existing in the OS 211 and identifies the structures of the respective applications 212 (at operation S134). The obtaining unit 178 analyzes the inside of the structure of the identified application 212 and obtains the use areas of the respective applications 212 (at operation S135). The obtaining unit 178 calculates the sizes of the use areas based on the obtained use areas (at operation S136).

The obtaining unit 178 analyzes the inside of the structure of the application 212 and obtains the application names and file names of the respective applications 212 as the identification information (at operation S137). The obtaining unit 178 stores the obtained use areas and sizes in the area file 151 in association with the VM-ID and the identification information (at operation S138). Furthermore, the obtaining unit 178 analyzes the inside of the structures of the respective applications 212 and determines whether or not the swap-out state exists (at operation S139). When it is determined that the swap-out state exists (at operation S139: YES), the obtaining unit 178 obtains the block number of the HD 15 which is the set aside destination (at operation S1310).

The obtaining unit 178 stores the obtained block number related to the application 212 in the area file 151 in association with the VM-ID (at operation S1311). When it is determined that the swap-out state does not exist (at operation S139: NO), the obtaining unit 178 skips the processing in operations S1310 and S1311.

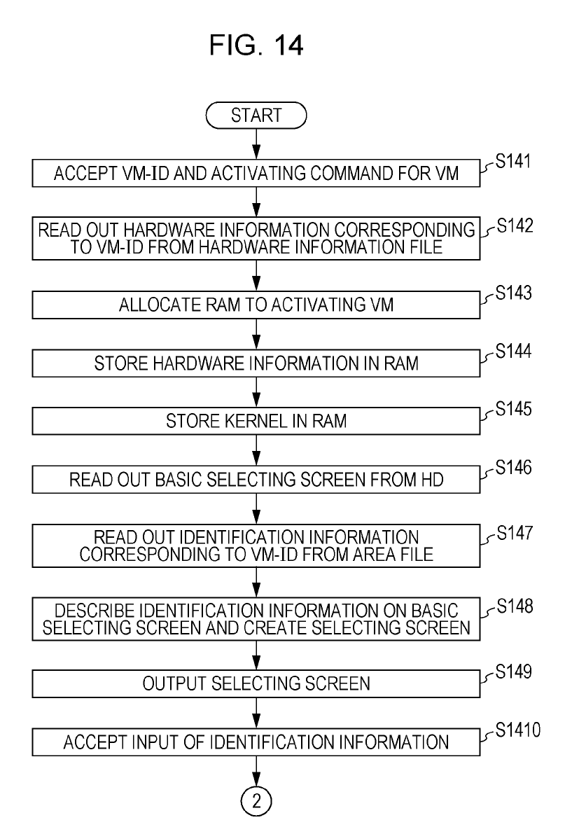

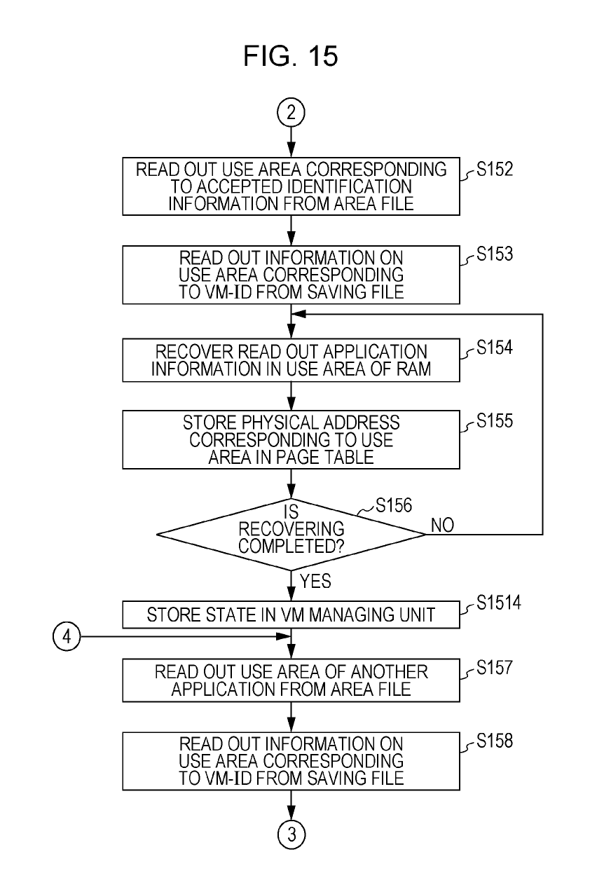

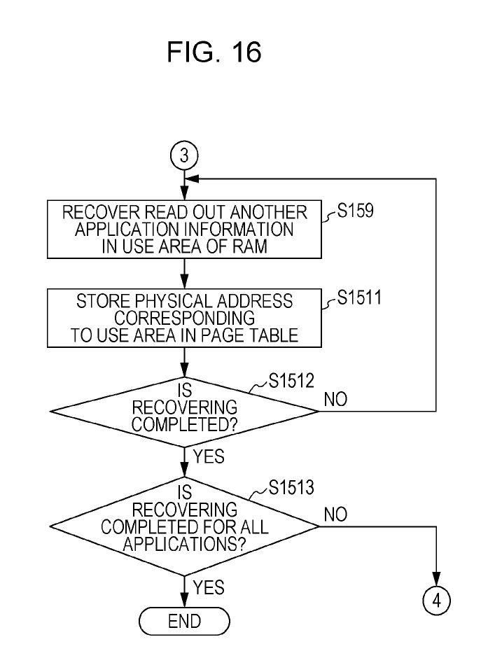

FIGS. 14 to 16 are operation charts representing examples of a procedure of resuming processing. As in the generation of the area file 151 represented in FIG. 13, when the VM 2 in the suspended state is activated, the CPU 11 performs the following processing. The user who desires the activation of the VM 2 in the suspended state outputs the activating command and the activating target VM-ID from the computer 3. The activating unit 179 accepts the VM-ID and the activating command for the VM 2 via the NIC 16 (at operation S141). The activating unit 179 outputs the activating command to the resuming unit 173. The resuming unit 173 reads out the hardware information corresponding to the VM-ID from the hardware information file 152 (at operation S142). The resuming unit 173 performs the allocation of the use area of the RAM 12 to the activating target VM group 2 (at operation S143).

The resuming unit 173 stores the hardware information on the VM 2 read out in operation S142 in the RAM 12 (at operation S144). The resuming unit 173 reads out the OS 211 corresponding to the VM-ID from the saving file 153. The resuming unit 173 stores the read out OS 211 in the area of the RAM 12 allocated in operation S143 (at operation S145). The selecting unit 172 reads out the basic selecting screen which is a previously stored template from the HD 15 (at operation S146). The selecting unit 172 reads out the identification corresponding to the VM-ID from the area file 151 (at operation S147).

The selecting unit 172 describes the identification information on the read out basic selecting screen and generates the selecting screen 34 (at operation S148). The selecting unit 172 outputs the generated selecting screen 34 via the NIC 16 to the computer 3 (at operation S149). According to this, on the display unit of the computer 3, the selecting screen 34 represented in FIG. 8 is displayed. The user selects the identification information desired to be preferentially resumed among the identification information displayed on the computer 3. The user clicks the check box 341 for selecting the identification information via the mouse or the like and clicks the enter button 342. The computer 3 outputs the VM-ID and the identification information as the selection information to the physical machine 1, using the click of the enter button 342 as a trigger.

The selecting unit 172 accepts an input of the VM-ID and the identification information via the NIC 16 (at operation S1410). The selecting unit 172 outputs the selected identification information to the resuming unit 173. The resuming unit 173 reads out the use area corresponding to the received identification information from the area file 151 (at operation S152). The resuming unit 173 reads out the information on the relevant use area corresponding to the VM-ID from the saving file 153 (at operation S153).

The resuming unit 173 resumes the read out information on the application 212 in the use area read out in operation S152 with respect to the RAM 12 allocated in operation S143 (at operation S154). The use area becomes a relative area with respect to the area of the RAM 12 allocated in operation S143. Hereinafter, the processing of resuming the use area (virtual address) in the RAM 12 is for the relative area to the allocated RAM 12. When the resuming unit 173 resumes the information in the use area, the physical address of the RAM 12 corresponding to the use area is stored in the page table 175 (at operation S155). The resuming unit 173 determines whether or not all the information read out in operation S153 is resumed in the use area (at operation S156).

When the resuming unit 173 determines that the resuming is not completed (at operation S156: NO), the operation is shifted to operation S154, and the processing is repeatedly performed. When the resuming unit 173 determines that the resuming is completed (at operation S156: YES), resuming completion information is output to the VM managing unit 174. When the resuming completion information is received, the VM managing unit 174 stores the state as “operating” (at operation S1514). The resuming unit 173 resumes the information except for the identification information accepted in operation S1410. That is, the resuming processing for the other application 212 whose priority processing is not desired by the user is performed. The resuming unit 173 reads out the use area of the other application 212 from the area file 151 (at operation S157).

The resuming unit 173 reads out the information on the user area corresponding to the VM-ID from the saving file 153 (at operation S158). The resuming unit 173 resumes the other read out information on the application 212 in the use area of the RAM 12 read out in operation S157 with respect to the RAM 12 allocated to the VM 2 in operation S143 (at operation S159). Each time information is stored in the use area of the RAM 12 (virtual address), the resuming unit 173 stores the physical address of the RAM 12 corresponding to the use area in the page table 175 (at operation S1511). The resuming unit 173 determines whether or not the resuming is completed (at operation S1512).

When the resuming unit 173 determines that the resuming is not completed (at operation S1512: NO), the operation is shifted to operation S159, and the processing is repeatedly performed. When the resuming unit 173 determines that the resuming is completed (at operation S1512: YES), it is determined whether or not the resuming of the information on the application 212 related to all the identification information stored in the area file 151 is completed (at operation S1513). When the resuming unit 173 determines that the resuming of all the information related to the application 212 is not completed (at operation S1513: NO), the operation is shifted to operation S157, and the resuming of the information on the application 212 related to the identification information which is not resumed yet is repeatedly executed.

When the resuming unit 173 determines that the resuming of the information on the application 212 related to all the identification information is completed (at operation S1513: YES), the processing is completed.

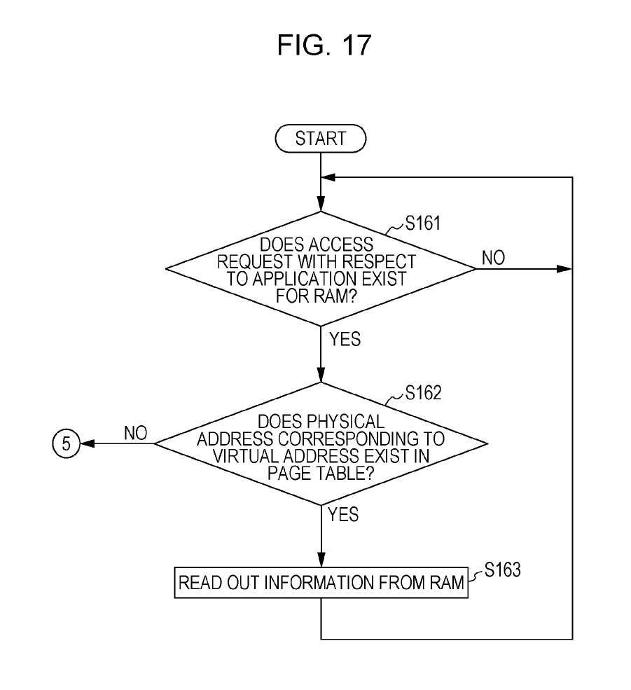

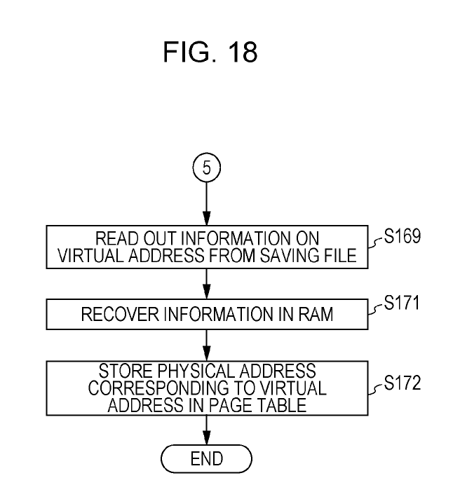

FIGS. 17 and 18 are operation charts representing examples of a procedure of a page fault processing. While the processing in operations S157 to S1513 is being completed, when the information corresponding to the physical address of the RAM 12 is not resumed, the page fault processing is executed.

The resuming unit 173 determines whether or not the access request to the application 212 exists for the RAM 12 in resuming from the computer 3 (at operation S161). When the resuming unit 173 determines that the access request does not exist (at operation S161: NO), the above processing is repeatedly performed. On the other hand, when the resuming unit 173 determines that the access request exists (at operation S161: YES), the resuming unit 173 determines whether or not the physical address corresponding to the virtual address exists in the page table 175 (at operation S162).

When the resuming unit 173 determines that the physical address exists (at operation S162: YES), as the resuming with respect to the relevant application 212 is already completed, the information is read out from the RAM 12 (at operation S163), and the processing advances.

After that, the processing returns to S161. When the resuming unit 173 determines that the physical address corresponding to the virtual address having an access does not exist in the page table 175 (at operation S162: NO), as the resuming is not completed, the page fault processing is performed as follows.

The resuming unit 173 reads out the information corresponding to the virtual address from the saving file 153 (at operation S169).

The resuming unit 173 resumes the read out information in the use area of the RAM 12 (virtual address) (at operation S171). The resuming unit 173 stores the physical address corresponding to the virtual address in the page table 175 (at operation S172). According to this, when the VM 2 in the suspended state is activated, it is possible to preferentially resumer the application 212 desired by the user. Also, the RAM 12 used by the other application 212 may be resumed by way of back ground, page fault, or the like.

### Embodiment 2

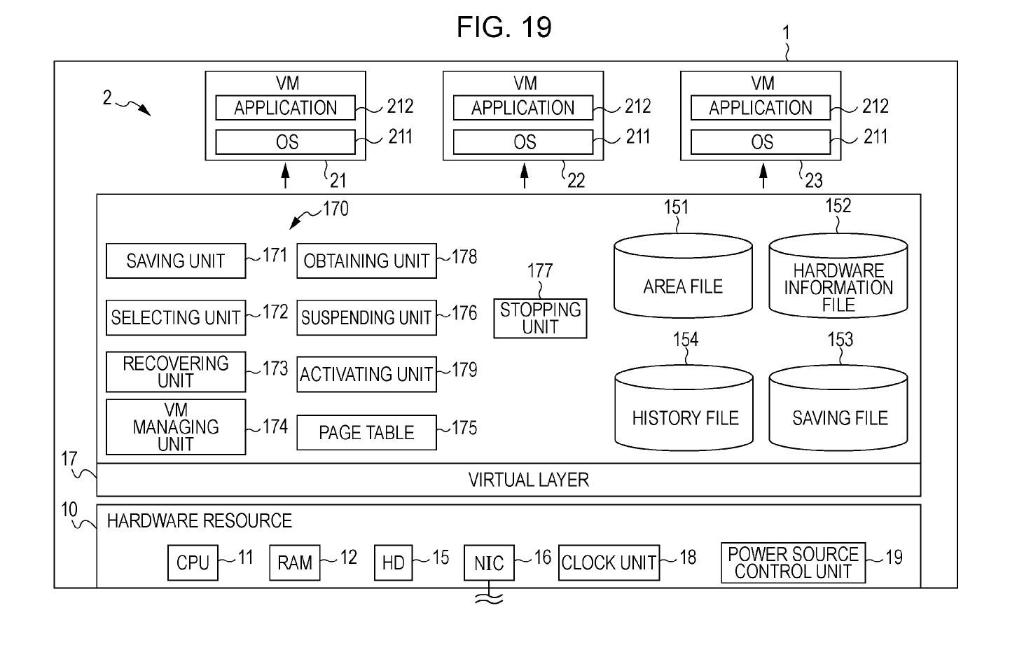

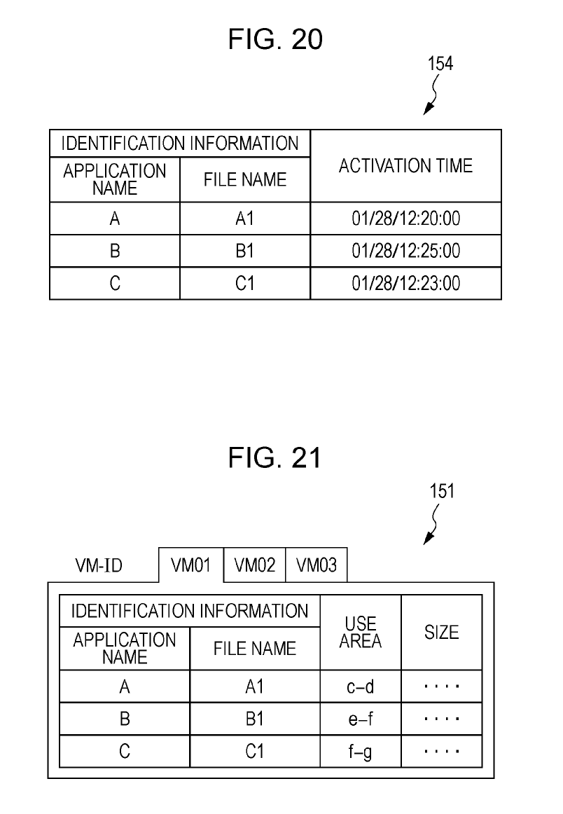

Embodiment 2 relates to a mode in which the use area of the RAM 12 used by the application 212 is stored in the area file 151 before the suspending processing. FIG. 19 is a block diagram depicting an example of hardware and software of the physical machine 1 and the VM 2 according to Embodiment 2. The physical machine 1 is provided with a history file 154. FIG. 20 is an explanatory diagram representing an example of a record layout of the history file 154. The history file 154 stores the activating time in association with the identification information for each VM 2 of the application 212. The example of FIG. 20 depicts a history file of the application 212 of the VM 21. The OS 211 of each VM 2 outputs information on the application name, the file name, the use area, and the like of the application 212 activated in each VM 2 to the obtaining unit 178. The obtaining unit 178 stores history information related to the use of the application 212 in the history file 154.

The history file 154 includes an application name field, a file name field, and an activating time field. According to the present embodiment, the application name and the file name are described as identification information for identifying the application 212 being executed. In the application name field, for each VM 2, the name of the application being executed in the VM 2 is stored. In the file name field, the file name related to the application 212 being executed is stored in association with the application name. In the activating time field, a use start time of the application 212 is stored which is output from the clock unit 18 when the respective application 212 is activated (hereinafter, which will be referred to as “activating time”). According to the present embodiment, for facilitating the explanation, only date and time are displayed, but year may also be stored.

The OS 211 of the VM 2 outputs the name of the application being executed and the file name to the obtaining unit 178 each time the application 212 is activated. The obtaining unit 178 stores the application name and the file name thus obtained in the history file 154 for each VM 2. Also, the obtaining unit 178 refers to the output of the clock unit 18 and stores the activating time in the history file 154. The activating time may also be obtained from the OS 211. FIG. 21 is an explanatory diagram representing an example of a record layout of the area file 151 according to Embodiment 2. The area file 151 includes the application name field, the file name field, the use area field, the size field, and the like. In the application name field, the name of the application being executed in the VM 2 is stored for each VM 2. Also, in the file name field, the file name related to the application 212 being executed is stored.

In the use area field, the use area of the RAM 12 used by the file of the application 212 is stored in association with the identification information. In the size field, the size of the use area of the RAM 12 used by the file of the application 212 is stored in association with the identification information. The block number is the same as described according to Embodiment 1, and therefore a description thereof is omitted. The OS 211 of the VM 2 outputs the information on the application name, the file name, and the use area to the obtaining unit 178 when the application 212 is activated, the use area of the RAM 12 is changed, or a stoppage or the like occurs.

The obtaining unit 178 stores the application name, the file name, and the use area thus obtained in the area file 151 in association with the VM 2. Also, the obtaining unit 178 calculates the size from the obtained use area to be stored in the area file 151 in association with the identification information. The OS 211 of the VM 2 collects the information on the application 212 being activated. Similarly as in Embodiment 1, the obtaining unit 178 may obtain the application name, the file name, and the use area from the OS 211 of the RAM 12 used by each VM 2 at regular time intervals.

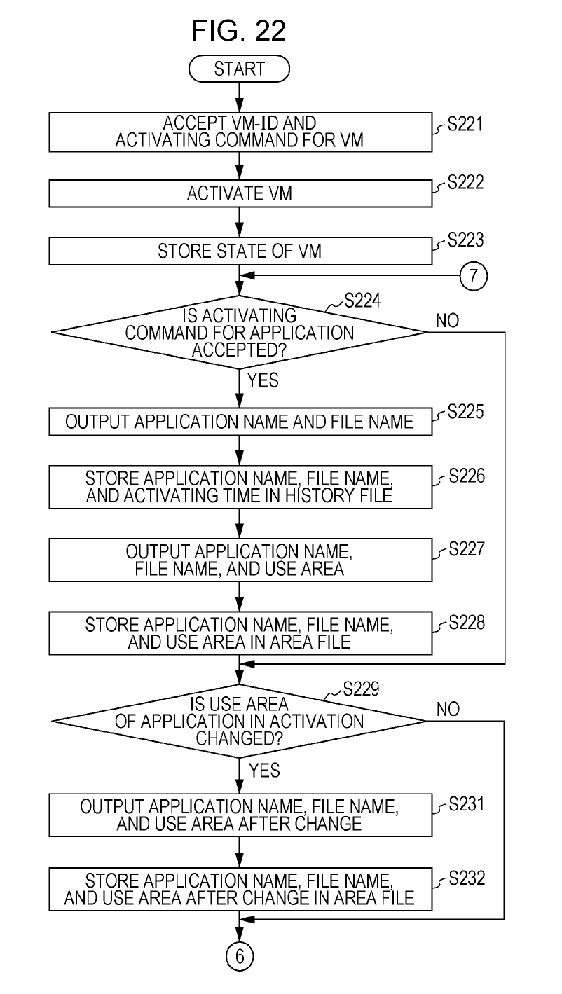

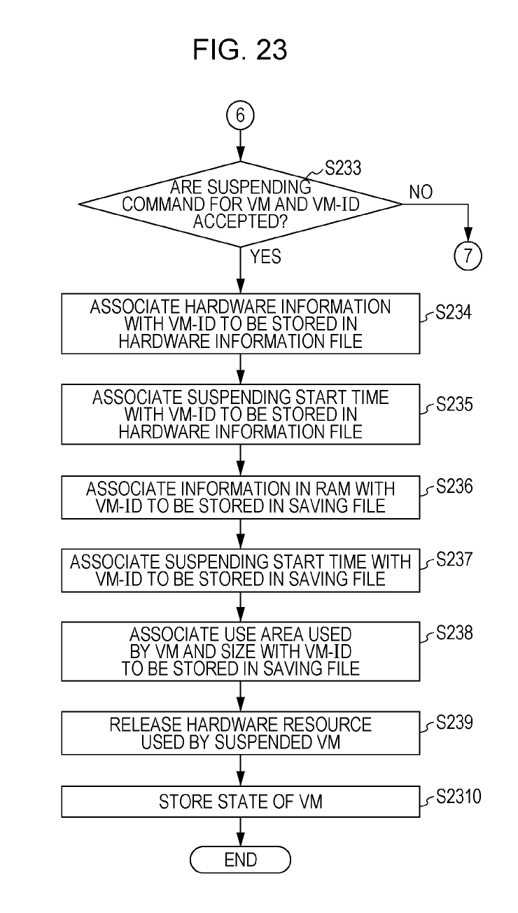

FIGS. 22 and 23 are operation charts representing examples of a procedure of the suspending processing. The user specifies the VM 2 desired to use after the activation of the physical machine 1 by using the computer 3. The computer 3 outputs the VM-ID and the activating command for the VM 2 to the physical machine 1. The activating unit 179 of the physical machine 1 accepts the VM-ID and an activating command for the VM 2 via the NIC 16 (at operation S221). The activating unit 179 activates the VM 2 (at operation S222). In the VM 2, the OS 211 is activated. The VM managing unit 174 stores the state “operating” in association with the VM-ID (at operation S223).

The OS 211 determines whether or not the activating command for the application 212 is accepted (at operation S224). When it is determined that the activating command is accepted (at operation S224: YES), the OS 211 outputs the name of the activated application and the file name to the obtaining unit 178 (at operation S225). The obtaining unit 178 obtains the application name and the file name. The obtaining unit 178 stores the application name and the file name thus obtained and the time output from the clock unit 18 as the activating time in the history file 154 in association with the VM-ID (at operation S226). When an end command for the application 212 is accepted, the name of the application accepting the end command, the file name, and the activating time are deleted from the history file 154.

The OS 211 outputs the application name, the file name, and the use area of the RAM 12 used by the activated application 212 to the obtaining unit 178 (at operation S227). The obtaining unit 178 obtains the application name, the file name, and the use area. The obtaining unit 178 stores the application name, the file name, and the use area in the area file 151 in association with the VM-ID (at operation S228). When the activating command for the application 212 is not accepted (at operation S224: NO), the OS 211 skips the processing in operations S225 to S228.

The OS 211 determines whether or not a change occurs in the use area with respect to the RAM 12 of the application 212 being activated (at operation S229). When the OS 211 determines that the change occurs in the use area (at operation S229: YES), the application name, the file name, and the use area after the change are output to the obtaining unit 178 (at operation S231). The obtaining unit 178 stores the application name, the file name, and the use area after the change in the area file 151 in association with the VM-ID (at operation S232). According to this, for each application name and file name, the information on the use history is updated. When the end command for the application 212 is accepted, the name of the application accepting the end command, the file name, and the use area are deleted from the area file 151.

When the OS 211 determines that the use area of the other application 212 being activated is not changed (at operation S229: NO), the processing in operations S231 and S232 is skipped. When the suspending of the VM 2 is desired, the user inputs the suspending command from the computer 3. The computer 3 outputs the suspending command for the VM 2 and the target VM-ID. The suspending unit 176 determines whether or not the suspending command for the VM 2 and the VM-ID are accepted via the NIC 16 from the computer 3 (at operation S233). When the suspending unit 176 determines that the suspending command of the VM-ID is not accepted (at operation S233: NO), the processing returns to operation S224. On the other hand, when the suspending unit 176 determines that the suspending command for the VM 2 and the VM-ID are accepted (at operation S233: YES), the suspending command is output to the storing unit 171.

The storing unit 171 stores the hardware information related to the VM 2 which is the suspending target in the RAM 12 in the hardware information file 152 in association with the VM-ID (at operation S234). In this case, the storing unit 171 stores the time output from the clock unit 18 as the suspending start time in the hardware information file 152 in association with the VM-ID (at operation S235). The storing unit 171 stores the information in the RAM 12 used by the suspending target VM 2 in the saving file 153 in association with the VM-ID (at operation S236).

The storing unit 171 stores the time output from the clock unit 18 as the suspending start time in the saving file 153 in association with the VM-ID (at operation S237). In addition, the storing unit 171 stores the use area and the size of the RAM 12 used by the suspending target VM 2 in the saving file 153 in association with the VM-ID (at operation S238). When the processing in operation S238 is completed, the storing unit 171 outputs the completion information to the suspending unit 176.

When the suspending unit 176 receives the completion information, the hardware resource 10 such as the RAM 12 used by the suspended target VM 2 is released (at operation S239). The VM managing unit 174 stores the state “suspended” in association with the VM-ID (at operation S2310). The processing when the activating command is accepted after the suspending processing is the same as represented in FIGS. 14 to 16, and a description thereof is omitted. In operation S229, the OS 211 determines the use area change of the other application 212, but other than this, as the area used by the application 212, the area of the OS 211 may also be included. In that case, operation S145 is skipped. The description will be provided while giving an example in which the output from the selecting screen 34 represented in FIG. 8 is displayed at the time of the activation, but the configuration is not limited to the above.

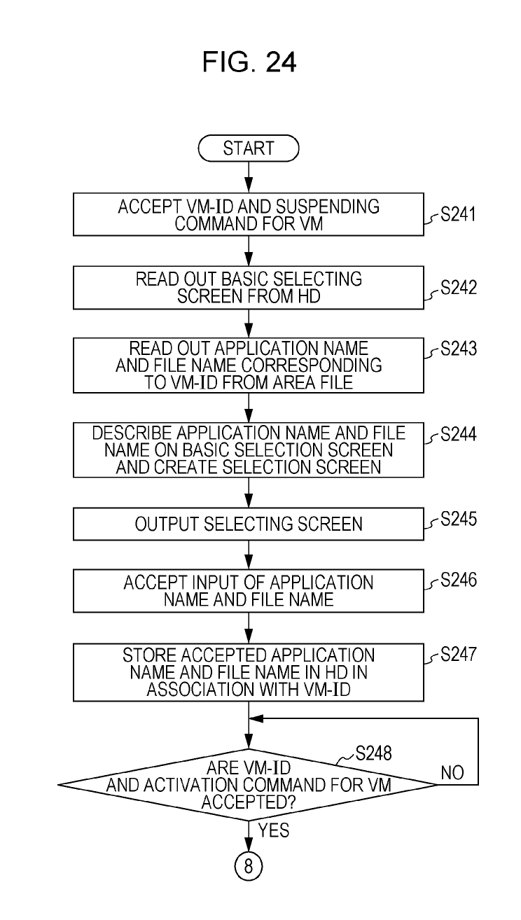

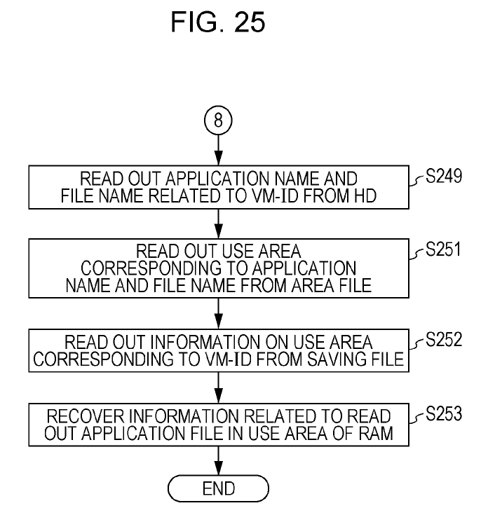

According to Embodiment 2, a reference is made to the area file 151 at the time of the suspending, and the input may be accepted of the identification information on the application 212 to be preferentially resumed after the activation before the VM 2 is suspended. FIGS. 24 and 25 are operation charts representing examples of a procedure of receiving an input of the identification information before the suspending processing. During the operations from S233 up to S238, the following processing is performed. The suspending unit 176 accepts the VM-ID and the suspending command for the VM 2 via the NIC 16 from the computer 3 (at operation S241). The suspending unit 176 outputs the suspending command to the selecting unit 172. The selecting unit 172 reads out the basic selecting screen from the HD 15 (at operation S242).

The selecting unit 172 reads out the application name and the file name corresponding to the VM-ID in activation from the area file 151 (at operation S243). The selecting unit 172 describes the application name and the file name on the basic selecting screen and generates the selecting screen 34 (at operation S244). The selecting unit 172 outputs the selecting screen 34 via the NIC 16 to the computer 3 (at operation S245). According to this, the selecting screen 34 represented in FIG. 8 is displayed on the display unit of the computer 3. The user selects the identification information desired to be preferentially resumed among the identification information displayed on the computer 3. The user clicks the check box 341 for selecting the identification information via the mouse or the like and clicks the enter button 342. The computer 3 outputs the VM-ID and the identification information to the physical machine 1 using the click of the enter button 342 as a trigger.

The selecting unit 172 accepts the input of the application name and the file name via the NIC 16 in addition to the VM-ID (at operation S246). The selecting unit 172 stores the accepted application name and file name in the HD 15 in association with the VM-ID (at operation S247). After that, the processing in operations S239 and S2310 are performed, and the suspending target VM 2 is suspended.

Subsequent to the suspending of VM2, the processing at the time of the activation will be described. The activating unit 179 determines whether or not the VM-ID and the activating command for the VM 2 are accepted (at operation S248). When the activating command is not accepted (at operation S248: NO), the activating unit 179 stands by until the activating command is accepted. On the other hand, when it is determined that the activating command is accepted (at operation S248: YES), the activating unit 179 reads out the application name and the file name related to the activating target VM-ID from the HD 15 (at operation S249). The activating unit 179 outputs the VM-ID and the activating command to the resuming unit 173.

The resuming unit 173 reads out the use area corresponding to the read out application name and file name from the area file 151 (at operation S251). The resuming unit 173 reads out the information on the user area corresponding to the read out VM-ID from the saving file 153 (at operation S252). The resuming unit 173 resumes the read out information related to the file of the application 212 in the use area of the RAM 12 (at operation S253). Subsequent processing is similar to the operation S155, and therefore a detailed description is omitted. According to this, it is possible for the user to select the application 212 desired to be preferentially resumed at the time of the suspending or activation.

This Embodiment 2 is as described above. Other components are similar to Embodiment 1. Thus, the corresponding parts are denoted by the same reference symbols, and a detailed description thereof is omitted. Also, a detail of the processing at the time of the activation is omitted, but after the activating command is accepted, the processing described according to Embodiment 1 is performed, for example the allocation of the RAM 12 to the VM 2 or the read of the OS 211. In the following description, the processing at the time of the activation may also be omitted in some cases.

### Embodiment 3

Embodiment 3 relates to a mode in which the application 212 to be preferentially resumed is selected based on history information. When the VM 2 is activated, the selecting unit 172 refers to the history file 154 to read out the activating time of the application 212 used at the time of the suspending, from the history file 154. At time of the activation, the selecting unit 172 obtains the current time output from the clock unit 18. Based on the activating times of the respective applications 212 and the current time, the selecting unit 172 selects the application 212 to be preferentially resumed. An application 212 with a small difference between the activating time and the current time may be selected apart from the activating time date. Also, the number to be selected may be previously stored in the HD 15. In the present example, for facilitating the explanation, an example of selecting one application 212 will be described.

In addition, an application 212 may also be selected in a time slot after the current time with a small difference between the activating time and the current time excluding the year, month, and day of the activating time. In addition, an application 212 may also be selected from the activating time having the year, month, and day in a given period (for example, within three days) from the current time. According to the present embodiment, as an example, a description will be given of an example of selecting an application 212 having the year, month, and day in a given period from the current time also in a time slot after the current time with a small difference between the activating time and the current time excluding the year, month, and day of the activating time.

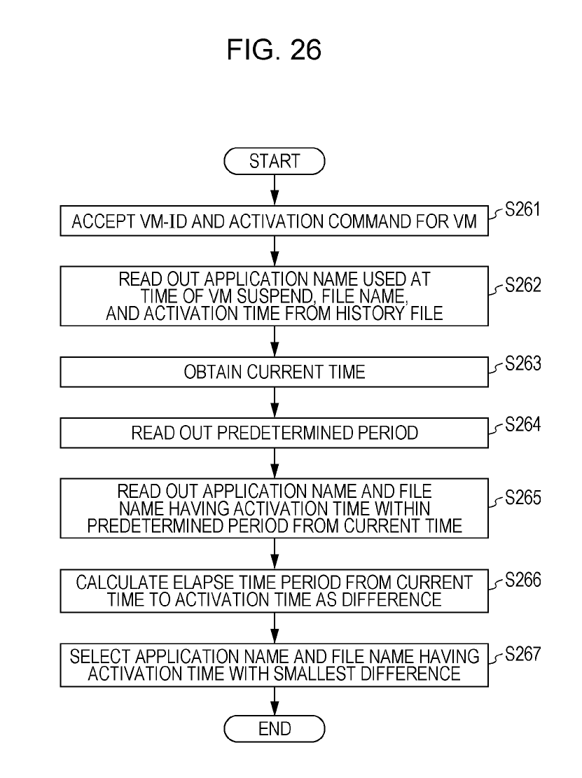

FIG. 26 is an operation chart representing an example of a procedure of the selection processing. The activating unit 179 accepts the VM-ID and the activating command for the VM 2 via the NIC 16 (at operation S261). The selecting unit 172 reads out the application name and the file name used when the VM 2 is suspended and the activating time from the history file 154 (at operation S262). The selecting unit 172 obtains a time including year, month, and day output from the clock unit 18 as the current time (at operation S263). The selecting unit 172 reads out a given period which is previously stored in the HD 15 (at operation S264). The given period may be set as an appropriate time using the computer 3.

The selecting unit 172 reads out the application name and the file name having the activating time within the given period extending back from the current time (at operation S265). The application name and the file name having the activating time within three days extending back from the current time may be selected, for example. The selecting unit 172 calculates an elapsed time from the current time up to the activating time as a difference (at operation S266). For example, when the current time is 11:10 AM and the activating time is 12:10 PM, the difference which is the elapsed time is 1 hour. Also, when the current time is 11:10 AM and the activating time is 10:10 AM, the difference which is the elapsed time is 23 hours.

The selecting unit 172 selects the application name and the file name having the activating time with the smallest difference calculated in operation S266 (at operation S267). According to this, in accordance with the use history of the VM 2 by the user, it is possible to preferentially recover the most appropriate application 212.

This Embodiment 3 is as described above. Other components are similar to Embodiments 1 and 2. Thus, the corresponding parts are denoted by the same reference symbols, and a detailed description thereof is omitted.

### Embodiment 4

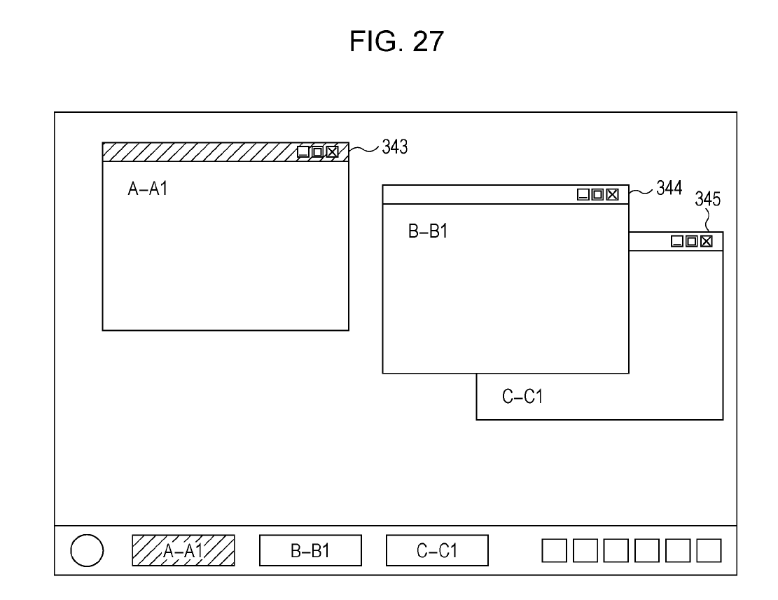

Embodiment 4 relates to a mode in which the most appropriate application 212 is selected in accordance with the use state of the application 212. FIG. 27 is an explanatory diagram representing an example of a screen image of the display unit of the computer 3. The user using the computer 3 is using three applications 212 in the VM 2 in operation. On the display unit, a window 343 of the application 212 with an application name “A” and a file name “A1”, a window 344 of the application 212 with an application name “B” and a file name “B1”, and a window 345 of the application 212 with an application name “C” and a file name “C1” are displayed. The user selects any one of the windows 343, 344, and 345 (hereinafter, which may be represented by W in some cases) desired to use by using the mouse or the like of the computer 3.

Information on the selected window W is output via the NIC 16 to the OS 211. In the example of the drawing, it is understood that the window 343 is selected. At this time, other windows 344 and 345 are in a non-selected state. When the window 344 is clicked in this state, the window 344 is selected, and in contrast, the windows 343 and 345 are in the non-selected state. The window W may also be selected by clicking a rectangular button displayed on a task bar which is displayed in a lower part of the display unit other than the selection by clicking the window W. The obtaining unit 178 stores the selection information in the history file 154 in association with the VM-ID, the application name, and the file name. The selection information is information indicating whether or not the application 212 is selected.

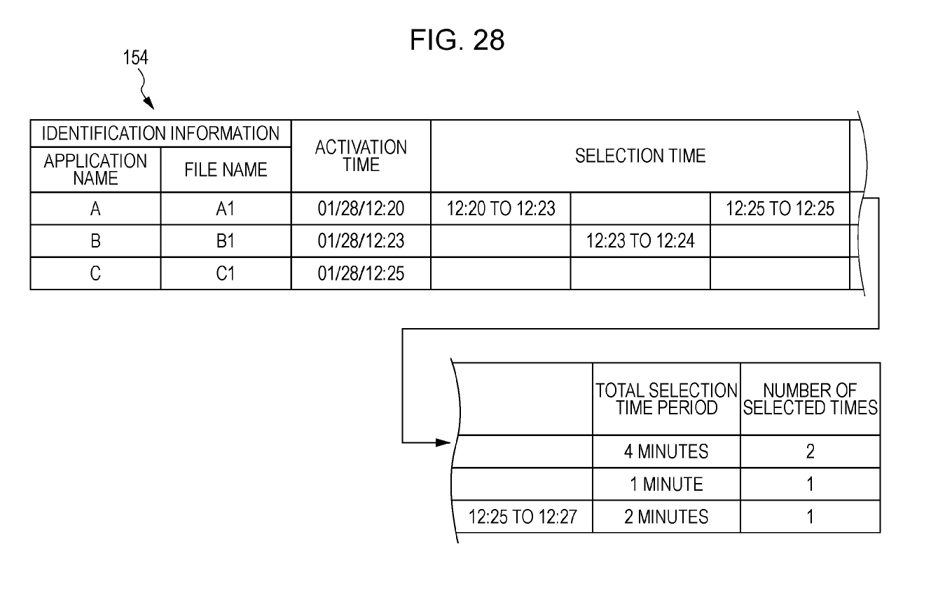

FIG. 28 is an explanatory diagram representing an example of a record layout of the history file 154. The history file 154 stores the activating time and the selection information in association with the identification information for each VM 2 of the application 212. The example of FIG. 28 depicts the use history of the application 212 of the VM 21. The history file 154 includes the application name field, the file name field, the activating time field, a selected time field, a total selected time period field, a number of selected times field, and the like. When the application 212 is activated, the OS 211 outputs the application name and the file name to the obtaining unit 178. The obtaining unit 178 obtains the application name and the file name output from the OS 211 to be stored in the history file 154. At this time, the obtaining unit 178 stores the time output from the clock unit 18 as the activating time in the history file 154. When the entire application 212 or a file of the application 212 is ended, the corresponding record of the history file 154 is deleted. Herein, the record is deleted as an example, but the history may be continuously held even after ending while it is represented that only the record of the activating time is invalid and is not activated and other records are held.

The OS 211 outputs the application name and the file name of the application 212 where the window W is selected to the obtaining unit 178. The obtaining unit 178 refers to the output from the clock unit 18 and stores a time at which the window W is selected (hereinafter, which will be referred to as “selected time”) in the selected time field in association with the selected application name and file name. For example, in the example of FIG. 28, from 12:20 (selecting start time) to 12:23 (selecting end time), the window 343 with the application name “A” and the file name “A1” is selected. Also, from 12:23 to 12:24, the window 344 with the application name “B” and the file name “B1” is selected. The OS 211 outputs the application name and the file name after the change each time the selection of the window W is changed.

The obtaining unit 178 refers to the application name and the file name after the change from the OS 211 and stores the selected time in the history file 154 as represented in FIG. 28. In this manner, with regard to the history file 154, the time information related to the use of the application 212 and the selection information indicating whether or not the application 212 is selected are sequentially stored in the selected time field. The obtaining unit 178 stores a total value of the selected times in the total selected time period field at the time of the suspending for each application 212. To be more specific, the obtaining unit 178 calculates the total value of the selected times of the application name and the file name to be stored as a total selected time period in the total selected time period field. For example, with regard to the application name “A” and the file name “A1”, the total selected time period is stored as 4 minutes while 1 minute is added to 3 minutes. According to the present embodiment, for facilitating the explanation, descriptions of second and year, month, and day are omitted.

In the number of selected times field, for each application 212, the number of times when the window W is selected is stored. The obtaining unit 178 counts the numbers in the time slot stored in the selected time field so that the number of selected times is stored for each application name and file name. For example, 2 is stored for the application name “A” and the file name “A1”, and 1 is stored for the application name “B” and the file name “B1”. Based on the information stored in the selected time field, the selecting unit 172 selects the application 212 to be preferentially resumed. According to the present embodiment, as an example, the description will be provided while giving an example in which the selecting unit 172 selects the application 212 having the longest total selected time period.

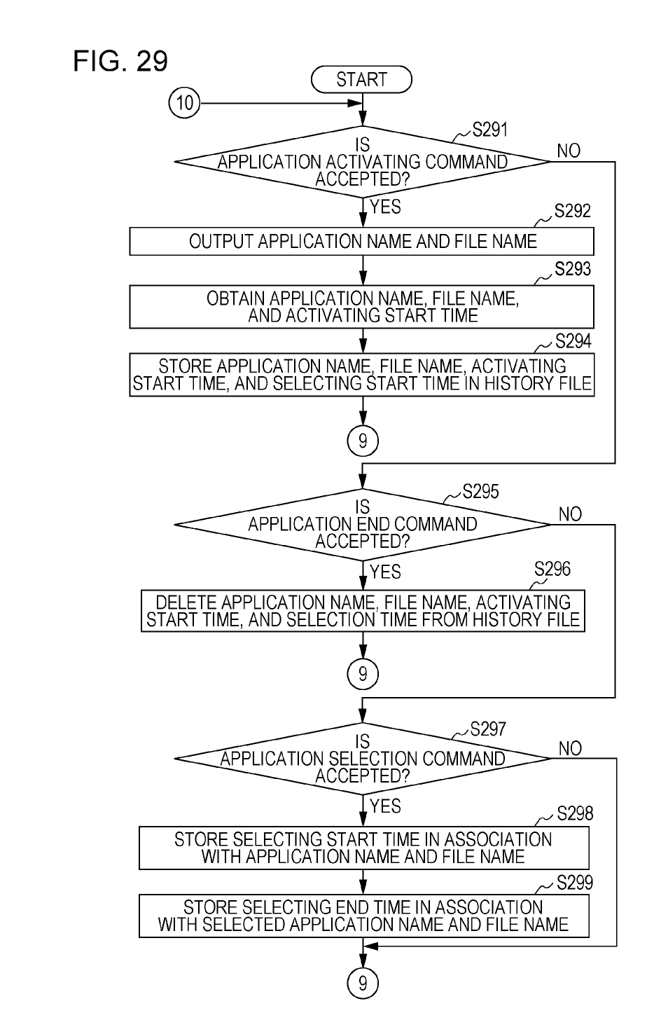

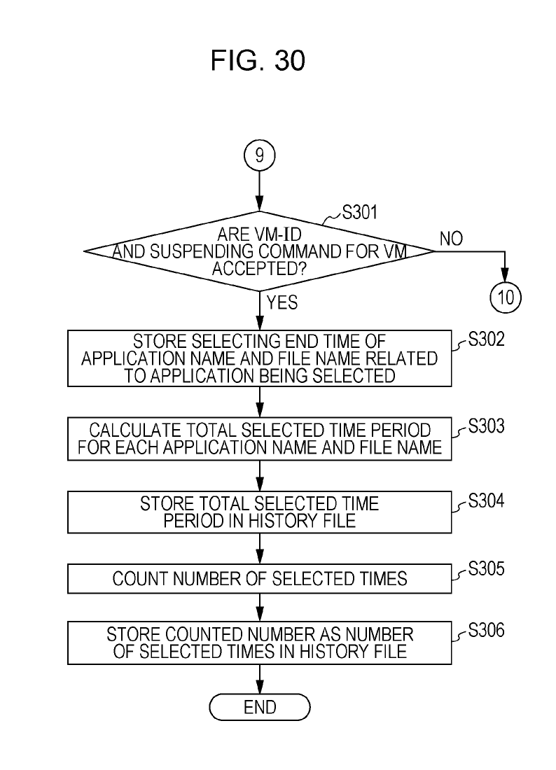

FIGS. 29 and 30 are operation charts representing examples of a procedure of the obtaining processing for the time information and the selection information. The OS 211 accepts the operation commands related to the application 212 via the NIC 16 from the computer 3. The OS 211 determines whether or not the activating command for the application 212 is accepted (at operation S291). When it is determined that the activating command is accepted (at operation S291: YES), the OS 211 outputs the application name and the file name to the obtaining unit 178 (at operation S292).

The obtaining unit 178 obtains the application name and the file name and also refers to the time output from the clock unit 18 to obtain the activating start time (at operation S293). The obtaining unit 178 sets the activating start time as the selecting start time. The obtaining unit 178 stores the application name, the file name, the activating start time, and the selecting start time in the history file 154 (at operation S294). Accordingly, in the selected time field of the history file 154, the selection information indicating that the application 212 is selected and the time information indicating that the selection is made and use is started are stored.

In operation S291, when it is determined that the activating command is not accepted (at operation S291: NO), the OS 211 determines whether or not the end command for the application 212 is accepted (at operation S295). When the OS 211 determines that the end command is accepted (at operation S295: YES), the application name and the file name of the end target application 212 are output to the obtaining unit 178. The obtaining unit 178 obtains the application name and the file name of the end target. The obtaining unit 178 deletes the obtained name of the end target application, the file name, the activating start time, and the selected time from the history file 154 (at operation S296).

When it is determined that the end command is not accepted (at operation S295: NO), the OS 211 determines whether or not the selection command for the application 212 is accepted (at operation S297). To be more specific, the OS 211 determines whether or not the window W of the application 212 is specified by the mouse or the like of the computer 3. When it is determined that the selection command is accepted (at operation S297: YES), the OS 211 outputs the application name and the file name related to the selected application 212 to the obtaining unit 178. The obtaining unit 178 obtains the output application name and file name.

The obtaining unit 178 stores the selecting start time in association with the application name and the file name (at operation S298). In operation S297, when the other application 212 is already selected, the obtaining unit 178 stores the selecting end time in association with the selected application name and file name (at operation S299). For example, in the example of FIG. 28, at 12:23, the application name “B” and the file name “B1” are newly selected while replacing the application name “A” and the file name “A1”. In this case, in order to store a situation in which the application name “B” and the file name “B1” are selected, the selecting start time (12:23) is stored in the history file 154 in association with the application name “B” and the file name “B1”. On the other hand, with regard to the application name “A” and file name “A1” whose selection is cancelled, in order to store a situation in which the selection is cancelled, the selecting end time (12:23) is stored in association with this.

When the OS 211 determines that the selection command for the application 212 is not accepted (at operation S297: NO) the operation is shifted to operation S301. Also, after operations S294, S296, and S299, the operation is similar shifted to operation S301. The suspending unit 176 determines whether or not the VM-ID and the suspending command for the VM 2 is accepted via the NIC 16 (at operation S301). When the suspending unit 176 determines that the suspending command is not accepted (at operation S301: NO), the processing returns to operation S291, and the processing is repeatedly performed. When the suspending unit 176 accepts the suspending command (at operation S301: YES), the suspending command is output to the obtaining unit 178. The obtaining unit 178 stores the selecting end time of the application name and the file name related to the currently selected application 212 in the history file 154 (at operation S302). For example, in the example of FIG. 28, the suspending command is issued at 12:27, and 12:27 is stored as the selecting end time of the currently selected application name “C” and file name “C1”.

The selecting unit 172 calculates the total selected time period for each application name and file name (at operation S303). To be more specific, the selecting unit 172 calculates a total value of times between the selecting start time and the selecting end time which are stored in the selected time field. The selecting unit 172 stores the total selected time period in the history file 154 (at operation S304). The selecting unit 172 counts the number of selected times while referring to the selected time field (at operation S305). The selecting unit 172 stores the counted number of selected times as the number of selected times in the history file 154 (at operation S306). The operations S302 to S306 may be carried out at the time of the activation. Also, the processing may also be carried out each time the application 212 is selected.

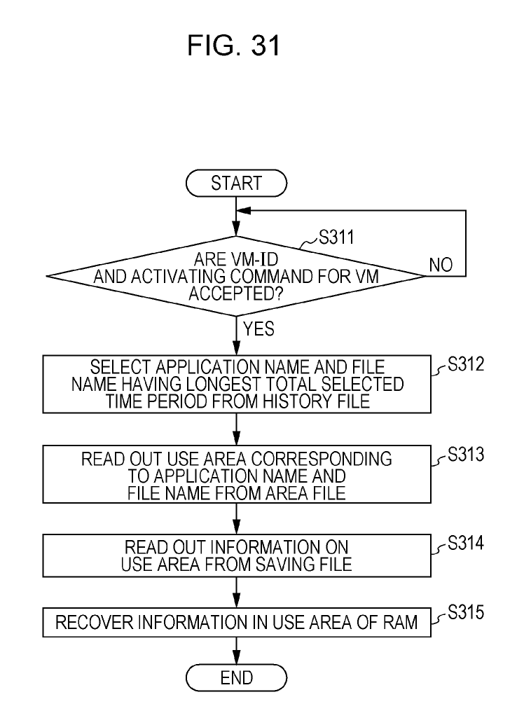

FIG. 31 is an operation chart representing an example of a procedure of the selection processing. The activating unit 179 determines whether or not the VM-ID and the activating command for the VM 2 are accepted via the NIC 16 (at operation S311). When it is determined that the activating command is not accepted (at operation S311: NO), the activating unit 179 stands by until the activating command is accepted. On the other hand, when it is determined that the activating command is accepted (at operation S311: YES), the activating unit 179 refers to the VM-ID and selects the application name and the file name having the longest total selected time period from the history file 154 (at operation S312). Furthermore, the resuming unit 173 reads out the use area corresponding to the application name and the file name from the area file 151 (at operation S313).

The resuming unit 173 reads out information on the use area from the saving file 153 (at operation S314). The resuming unit 173 resumes the read out information in the use area of the RAM 12 (at operation S315). Accordingly, the application 212 having a high use frequency is preferentially resumed and it is possible to increase the convenience for the user.

This Embodiment 4 is as described above. Other components are similar to Embodiments 1 to 3. Thus, the corresponding parts are denoted by the same reference symbols, and a detailed description thereof is omitted.

### Embodiment 5

Embodiment 5 relates to a mode in which the application 212 to be preferentially resumed is selected based on the activating time and the use history of the application 212. When the activating command is accepted, the selecting unit 172 selects the application 212 based on the time information related to the use of the application 212 and the selection information stored in the history file 154 as well as the time output from the clock unit 18. Hereinafter, a selection processing will be described by using an operation chart.

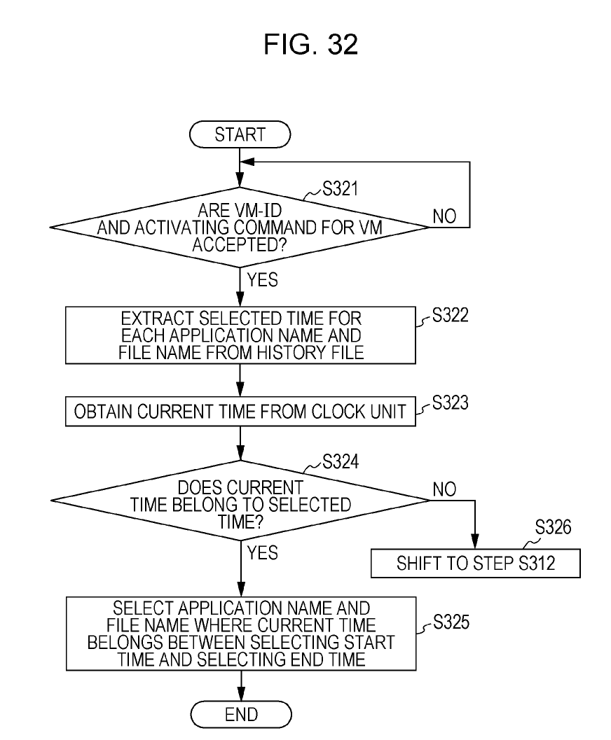

FIG. 32 is an operation chart representing an example of a procedure of the selection processing. The activating unit 179 determines whether or not the VM-ID and the activating command for the VM 2 are accepted via the NIC 16 (at operation S321). When it is determined that the activating command is not accepted (at operation S321: NO), the activating unit 179 stands by until the activating command is accepted. On the other hand, when the activating unit 179 determines that the activating command is accepted (at operation S321: YES), the selecting unit 172 refers to the VM-ID and extracts the selected time from the history file 154 for each application name and file name (at operation S322). The selecting unit 172 obtains the current time from the clock unit 18 (at operation S323). The selecting unit 172 determines whether or not the current time belongs to the selected time (at operation S324).

For example, in the example of FIG. 28, when the current time is 12:22, the current time belongs to the selected time. On the other hand, when the current time is 12:30, which is outside of a period from 12:20 to 12:27, the current time does not belong to the selected time. When the selecting unit 172 determines that the current time belongs to the selected time (at operation S324: YES), the operation is shifted to operation S325. The selecting unit 172 selects the application name and the file name in which the current time belongs between the selecting start time and the selecting end time (at operation S325). In the above-mentioned example, the current time 12:22 belongs between the selecting start time 12:20 and the selecting end time 12:23, and therefore the corresponding application name “A” and file name “A1” are selected. On the other hand, when the selecting unit 172 determines that the current time does not belong to the selected time (at operation S324: NO), the operation is shifted to operation S312 (at operation S326). The processing after the operation S312 is as described according to Embodiment 4, and therefore a detailed description is omitted. Also, the processing after the operation S325 is similar to the operations S313 to S315, and therefore a description is omitted. Accordingly, it is possible to recover the application 212 preferentially in accordance with the use of the VM 2 by the user.

This Embodiment 5 is as described above. Other components are similar to Embodiments 1 to 4. Thus, the corresponding parts are denoted by the same reference symbols, and a detailed description thereof is omitted.

### Embodiment 6

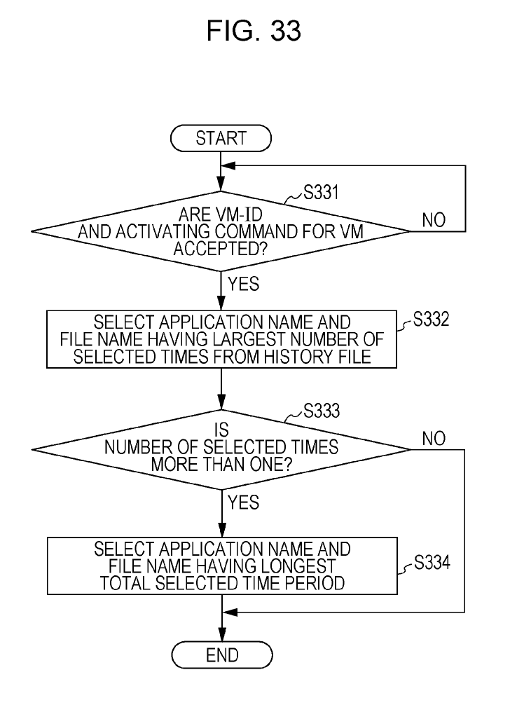

Embodiment 6 relates to a mode in which the application 212 to be preferentially resumed is selected in accordance with the number of selected times of the window W. FIG. 33 is an operation chart representing an example of a procedure of the selection processing. The activating unit 179 determines whether or not the VM-ID and the activating command for the VM 2 are accepted via the NIC 16 (at operation S331). When it is determined that the activating command is not accepted (at operation S331: NO), the activating unit 179 stands by until the activating command is accepted. On the other hand, when it is determined that the activating command is accepted (at operation S331: YES), the activating unit 179 refers to the VM-ID and selects the application name and the file name having the largest number of selected times from the history file 154 (at operation S332).

The selecting unit 172 determines whether or not the number of the application name and the file name selected in operation S332 is more than one (at operation S333). When it is determined that the number is not plural (at operation S333: NO), the selecting unit 172 ends the processing. On the other hand, when it is determined that the number is plural (at operation S333: YES), the selecting unit 172 selects the application name and the file name having a longer total selected time period (at operation S334). The subsequent processing and the processing after NO in operation S333 are similar to the operations S313 to S315, and therefore a description is omitted.

This Embodiment 6 is as described above. Other components are similar to Embodiments 1 to 5. Thus, the corresponding parts are denoted by the same reference symbols, and a detailed description thereof is omitted.

### Embodiment 7

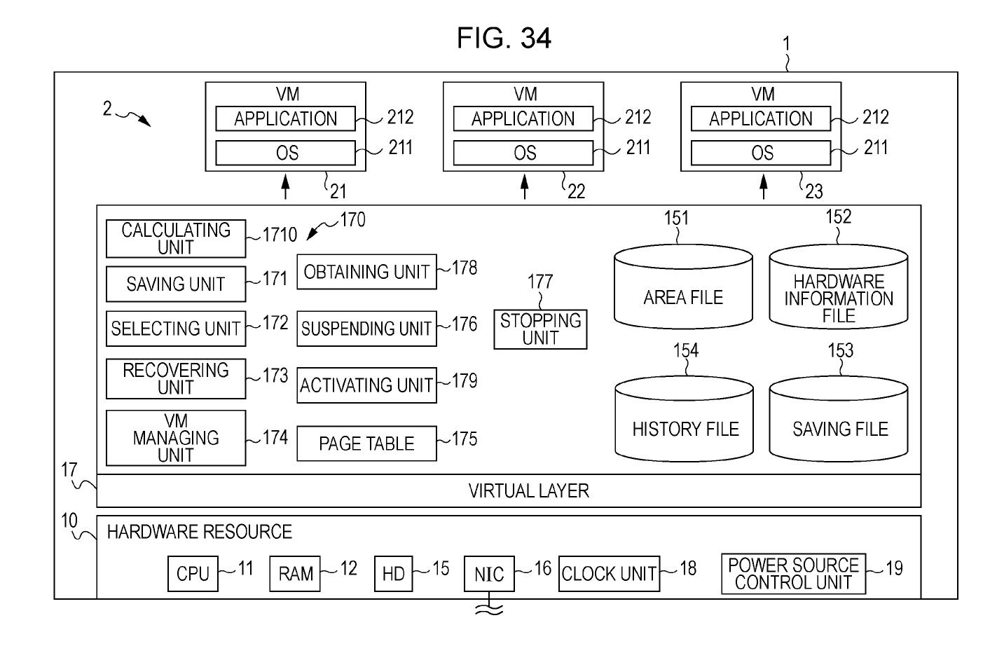

Embodiment 7 relates to a mode in which a priority is calculated, and a plurality of applications 212 are presented based on the calculated priority. FIG. 34 is a block diagram depicting an example of hardware and software of the physical machine 1 and the VM 2. Furthermore, as the control module 170, a calculating unit 1710 for calculating priorities is provided. The calculating unit 1710 calculates priorities based on the history information on the respective applications 212 stored in the history file 154. According to the present embodiment, the description will be provided while giving an example in which a higher priority is assigned to one with a larger number of selected times stored in the history file 154.

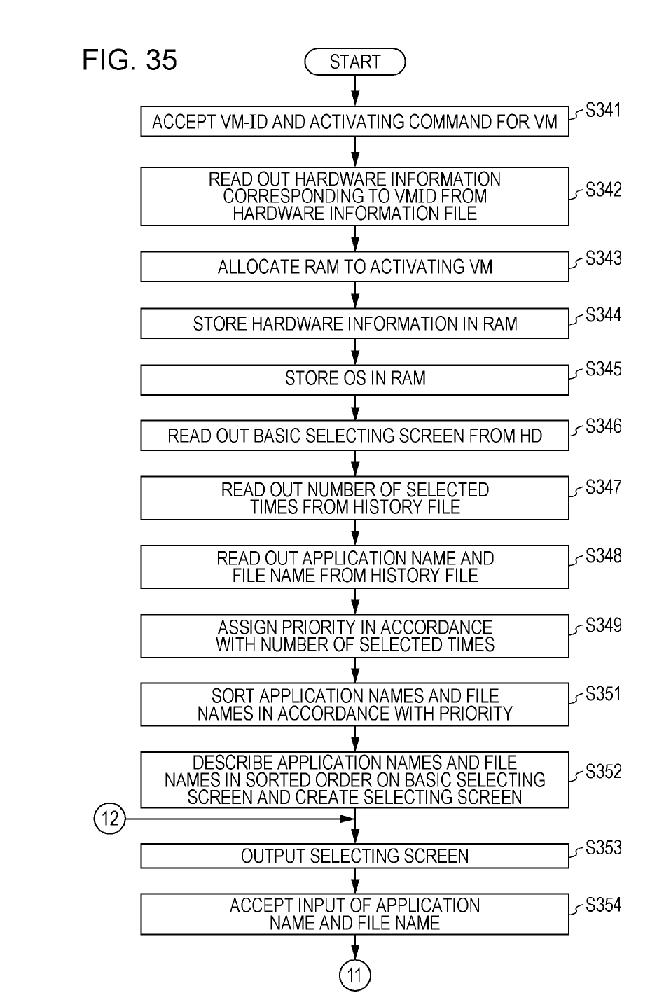

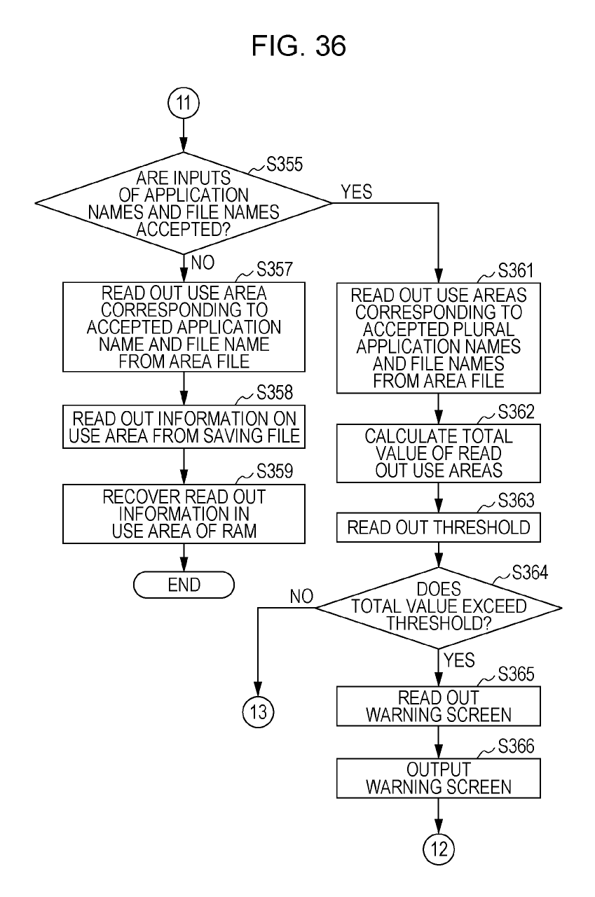

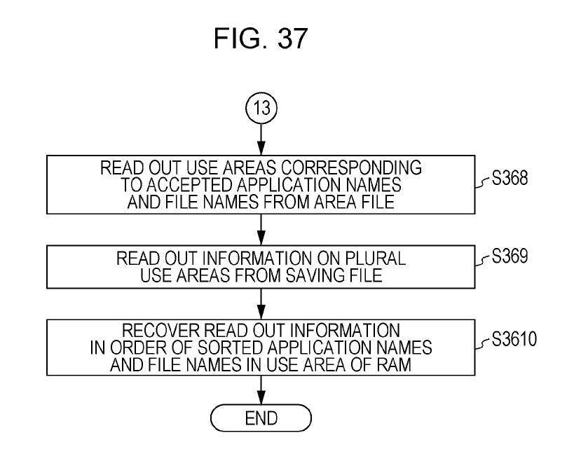

FIG. 35 to FIG. 37 are operation charts representing examples of a procedure of the selection processing based on priority. The activating unit 179 accepts the VM-ID and the activating command for the VM 2 via the NIC 16 (at operation S341). The activating unit 179 outputs the activating command to the resuming unit 173. The resuming unit 173 reads out the hardware information corresponding to the VM-ID from the hardware information file 152 (at operation S342). The resuming unit 173 performs the allocation of the use area of the RAM 12 to the activating target VM 2 (at operation S343).

The resuming unit 173 stores the hardware information on the VM 2 read out in the operation in S342 in the RAM 12 (at operation S344). The resuming unit 173 reads out the OS 211 corresponding to the VM-ID from the saving file 153. The resuming unit 173 stores the read out OS 211 in the area allocated in operation S343 (at operation S345). The selecting unit 172 reads out the basic selecting screen which is a previously stored template from the HD 15 (at operation S346). The calculating unit 1710 reads out the record of the history file 154 corresponding to the VM-ID for the activating target VM 2. Then, the calculating unit 1710 reads out the number of selected times for each application name and file name (at operation S347). The counting processing for the number of selected times is as described according to Embodiment 4, and therefore a detailed description is omitted. The calculating unit 1710 reads out the application name and the file name from the history file 154 (at operation S348).

The calculating unit 1710 assigns the priority in accordance with the read out number of selected times for each application name and file name (at operation S349). The priority may be set as “3”, for example, when the number of selected times is “3”. The selecting unit 172 sorts the application names and the file names in accordance with the priority (at operation S351). For the sorting, a processing of arranging the application names and the file names from the higher priority to the lower priority may be performed.

The selecting unit 172 describes the application names and the file names on the basis selecting screen in the sorted order and generates the selecting screen 34 (at operation S352). Also, the selecting unit 172 may describe the priority in association with the application names and the file names. The selecting unit 172 outputs the generated selecting screen 34 to the computer 3 via the NIC 16 (at operation S353).

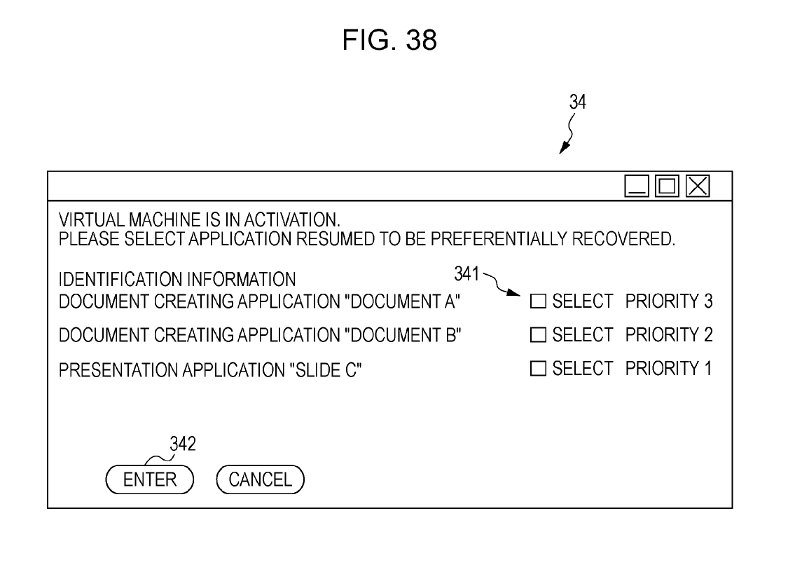

FIG. 38 is an explanatory diagram representing an example of an image of the selecting screen 34. On the selecting screen 34, the application names and the file names in the sorted order are displayed. A priority is displayed for each application name and file name. In the present example, the document creating application “Document A” is assigned with the priority 3 and also displayed on the top stage of the screen. The user clicks the application name and the file name to be preferentially resumed in the check box 341 from the mouse or the like of the computer 3. More than one item may be selected. After clicking the check box 341, the user clicks the enter button 342. Accordingly, from the computer 3, the VM-ID, the selected application name and file name or application names and file names are output to the physical machine 1.

The selecting unit 172 accepts the input of the application name and the file name output from the computer 3 (at operation S354). The selecting unit 172 determines whether or not inputs of more than one application name and file name are accepted (at operation S355). When the selecting unit 172 determines that there is only one input (at operation S355: NO), the application name and the file name input in operation S354 are selected to be preferentially resumed.

The selecting unit 172 outputs the selected application name and file name to the resuming unit 173. The resuming unit 173 reads out the use area corresponding to the accepted application name and file name from the area file 151 (at operation S357). The resuming unit 173 reads out the information on the relevant use area from the saving file 153 (at operation S358). When the area file 151 and the saving file 153 are read out, the resuming unit 173 reads out the record corresponding to the VM-ID accepted in operation S341.

The resuming unit 173 resumes the read out information related to the application name and the file name in the use area of the RAM 12 read in operation S357 (at operation S359). On the other hand, when the selecting unit 172 determines that more than one application name and file name are accepted (at operation S355: YES), the operation is shifted to operation S361. The selecting unit 172 reads out all the use areas corresponding to the accepted application names and file names from the area file 151 (at operation S361). The selecting unit 172 calculates a total value of the read out use areas (at operation S362). To be more specific, the selecting unit 172 adds all the use areas (sizes) of the RAM 12 of the respective applications 212.

The selecting unit 172 reads out a threshold stored in the HD 15 (at operation S363). Then, the selecting unit 172 determines whether or not the calculated total value exceeds the threshold (at operation S364). This is for preventing the user from selecting too many applications 212. This threshold may be set as an appropriate value via the computer 3 or also as a value obtained by multiplying the size allocated in operation S343 by a coefficient smaller than 1. When it is determined that the total value exceeds the threshold (at operation S364: YES), the selecting unit 172 reads out a warning screen stored in the HD 15 (at operation S365). The selecting unit 172 outputs the read out warning screen via the NIC 16 to the computer 3 (at operation S366).

The display unit of the computer 3 displays the warning screen such as “please select again.” or “exceeding memory capacity which can be resumed at once.” After that, the selecting unit 172 shifts to operation S353, and the above processing is repeatedly performed. On the other hand, when it is determined that the total value does not exceed the threshold (at operation S364: NO), the resuming unit 173 reads the use areas corresponding to the accepted application names and file names from the area file 151 (at operation S368). The resuming unit 173 reads out the information on the relevant plural pieces of information on the use areas from the saving file 153 (at operation S369).

The resuming unit 173 resumes the read out information related to the application name and the file name in the corresponding use areas of the RAM 12 read out in operation S358 in the sorted order of application names and file names (at operation S3610). In the example of FIG. 38, when the document creating application “Document A” and the presentation application “slide C” are selected, the resuming starts from the document creating application “Document A” with the higher priority. In this case, the resuming unit 173 reads out the use area stored in association with the document creating application “Document A” from the area file 151 and resumes the information on the document creating application “Document A” stored in the saving file 153 in the relevant area. After that, the resuming unit 173 reads out the use area stored in association with the presentation application “slide C” from the area file 151 and resumes the information on “slide C” stored in the saving file 153 in the area. Accordingly, the user may obtain the index for the preferential resuming, and it is possible to more efficiently use the application 212. Also, it is possible to eliminate reduction in activation processing speed due to a situation where too many applications 212 are selected. With regard to the non-selected application 212 too, by performing the processing in operations S157 to S1513 in the priority order, it is possible to efficiently recover the application 212.

This Embodiment 7 is as described above. Other components are similar to Embodiments 1 to 6. Thus, the corresponding parts are denoted by the same reference symbols, and a detailed description thereof is omitted.

### Embodiment 8

Embodiment 8 relates to a mode in which the priority is assigned based on the time information related to the use of the application 212 and the information on the time output from the clock unit 18 at the time of the activation. To be more specific, differences between the use start times of the respective applications 212 and the current time output from the clock unit 18 are calculated, and priorities are assigned in the order from smaller differences. Also, according to the present embodiment, the description will be provided while giving an example in which the selecting unit 172 selects the application 212 to be preferentially resumed based on the priorities.

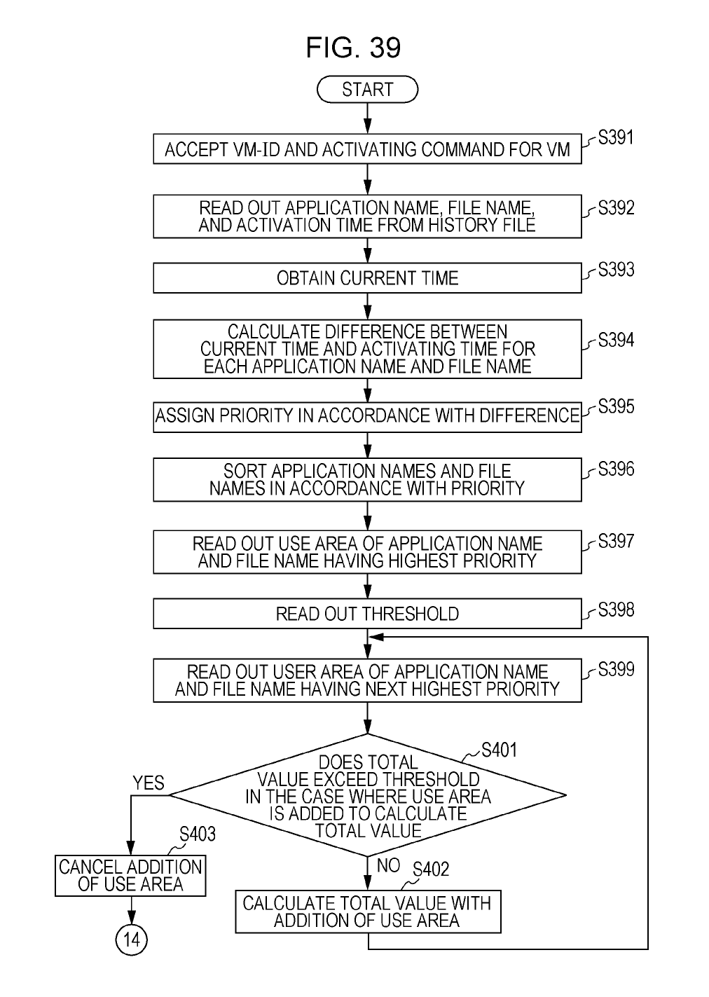

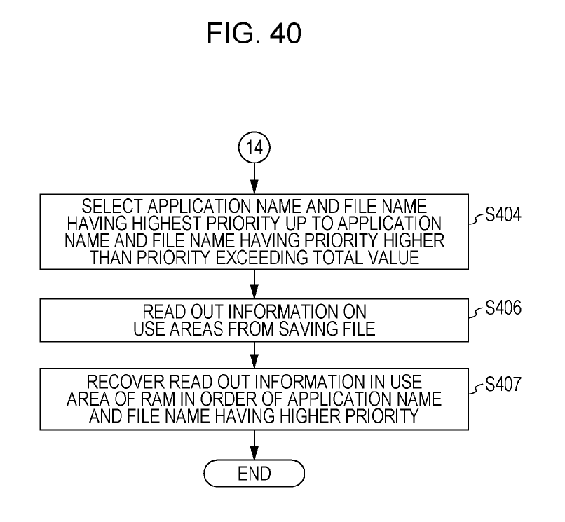

FIGS. 39 and 40 are operation charts representing examples of an assignment procedure for the priorities. The activating unit 179 accepts the VM-ID and the activating command for the VM 2 via the NIC 16 (at operation S391). The calculating unit 1710 reads out the application name, the file name, and the activating time as the time information related to the use of the application 212 from the history file 154 (at operation S392). The calculating unit 1710 reads out all the records of the applications 212 stored in the history file 154 among the records corresponding to the VM-IDs accepted in operation S391.

The calculating unit 1710 obtains the current time from the clock unit 18 (at operation S393). The calculating unit 1710 calculates a difference between the current time and the activating time for each application name and file name (at operation S394). When calculating the difference, the calculating unit 1710 may calculate a difference of times while excluding year, month, and day. In addition, while excluding year, month, and day, regarding the difference, the activating time after the current time may also be calculated with priority. The calculating unit 1710 assigns the priorities in accordance with the calculated differences (at operation S395). The priority may be set to be larger as the difference is smaller. For example, an inverse number of the difference may be set as the priority.

The selecting unit 172 sorts the application names and the file names in accordance with the priorities (at operation S396). The selecting unit 172 reads out the use area of the application name and the file name having the highest priority from the area file 151 (at operation S397). The selecting unit 172 reads the threshold (at operation S398). The selecting unit 172 reads the use area of the application name and the file name having the next highest priority in operation S397 from the area file 151 (at operation S399).

When the use area read out in operation S399 is added to the use area read out in operation S397 to calculate the total value, the selecting unit 172 determines whether or not the total value exceeds the threshold (at operation S401). When it is determined that the total value does not exceed the threshold (at operation S401: NO), the selecting unit 172 calculates the total value while the use area read out in operation S399 is added (at operation S402). Then, the processing returns to operation S399, and the processing is repeatedly performed. The selecting unit 172 reads out a new use area related to the application name and the file name having the next highest priority. This is repeatedly performed, and when it is determined that the total value exceeds the threshold (at operation S401: YES), the selecting unit 172 cancels the addition of the use area read out in operation S399 (at operation S403).

The selecting unit 172 selects from the application name and the file name having the highest priority read out in operation S397 the application name and the file name having a priority higher than the priority exceeding the total value in operation S401 (at operation S404). The resuming unit 173 reads out information on the plurality of selected use areas from the saving file 153 (at operation S406).

The resuming unit 173 resumes the read out information related to the application name and the file name in the order of the selected application names and file names having the higher priority in the corresponding use areas read out in operation S397 or S399 to the RAM 12 (at operation S407). Accordingly, with the limit of the previously set threshold, the applications 212 are preferentially resumed in accordance with the priority. According to the present embodiment, the selecting unit 172 automatically selects the application 212 to be resumed based on the priority, but the configuration is not limited to the above. As in Embodiment 7, the selecting screen 34 is displayed, and the user may select the application 212.

This Embodiment 8 is as described above. Other components are similar to Embodiments 1 to 7. Thus, the corresponding parts are denoted by the same reference symbols, and a detailed description thereof is omitted.

### Embodiment 9

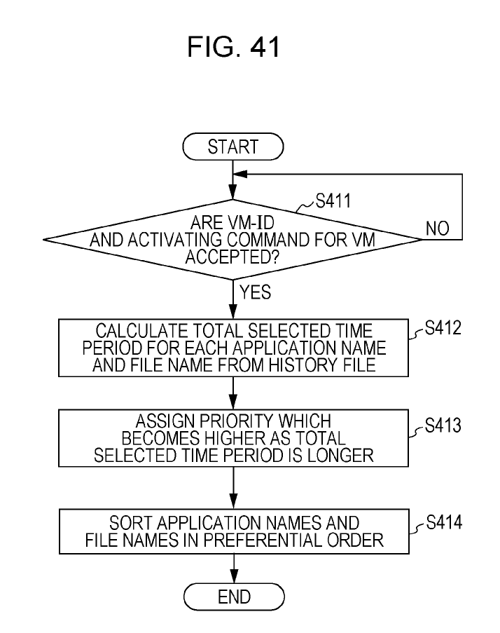

Embodiment 9 relates to a mode in which the priority is calculated based on time information on the use of each application 212 and selection information. FIG. 41 is an operation chart representing an example of a procedure of the priority calculation processing according to Embodiment 9. The activating unit 179 determines whether or not the activating target VM-ID and the activating command for the VM 2 are accepted from the computer 3 (at operation S411). When it is determined that the activating target VM-ID and the activating command are not accepted (at operation S411: NO), the activating unit 179 stands by until the acceptance. On the other hand, when it is determined that the activating command is accepted (at operation S411: YES), the activating unit 179 outputs the activating command to the calculating unit 1710.

The calculating unit 1710 reads out the record corresponding to the activating target VM-ID in the history file 154. The calculating unit 1710 refers to the selected time field indicating when the respective application names and file names are selected in the history file 154 and calculates the total selected time period for each application name and file name (at operation S412). The calculating unit 1710 stores the total selected time periods of the respective application names and file names calculated in the total selected time period field in the history file 154. The calculating unit 1710 assigns a higher priority as the total selected time period is longer (at operation S413).

The calculating unit 1710 sorts the application names and the file names in the preferential order of the assigned priorities (at operation S414). The processing in operation S412 to S414 is not only executed at the time of the activation of the VM 2 but may also be executed at the time of the suspending of the VM 2. When processing is executed at the time of the suspending, the priority calculated for each application name and file name is stored in the HD 15 in association with the VM-ID and read out at the time of the activation by using the VM-ID as the key. Also, as depicted in Embodiment 4, the processing only in operation S412 may be executed at the time of the suspending. According to this, as the priorities are assigned in accordance with the use situation by the user with respect to the respective applications 212 of the VM 2, it is possible to quickly use the desired application 212 of the VM 2.

This Embodiment 9 is as described above. Other components are similar to Embodiments 1 to 8. Thus, the corresponding parts are denoted by the same reference symbols, and a detailed description thereof is omitted.

### Embodiment 10

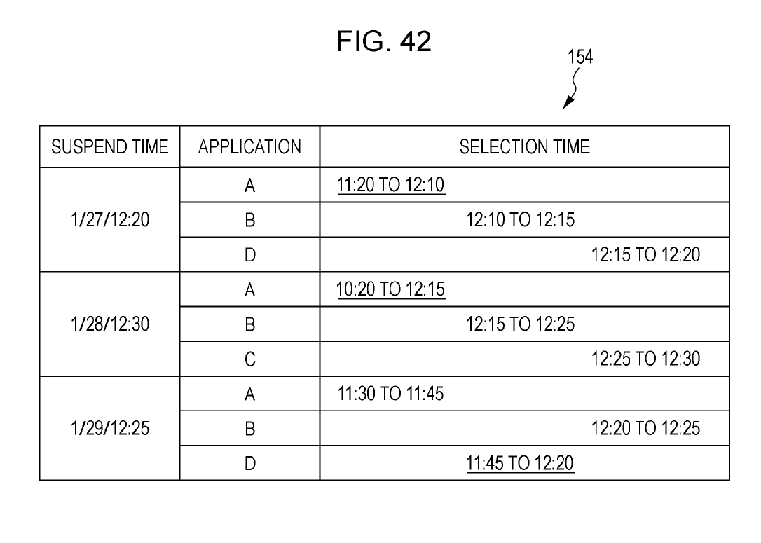

Embodiment 10 relates to a mode in which the priority is calculated based on a plurality of histories at the time of suspending. FIG. 42 is an explanatory diagram representing an example of a record layout of the history file 154 according to Embodiment 10. The history file 154 stores the application 212 executed by the VM 2 and the selected time for each suspending time. The history file 154 includes a suspending time field, an application field, the selected time field, and the like. The suspending time field stores a time at which the suspending command for the VM 2 is accepted from the computer 3. When the VM-ID and the suspending command for the VM 2 are received, the suspending unit 176 stores the suspending time output from the clock unit 18 in the history file 154. According to the present embodiment, an example will be described in which month, day, hour, and minute are used, but year as well as second may also be included.

The application field stores the application name of the application 212 executed at the time of the suspended state. According to the present embodiment, for facilitating the explanation, an example will be described in which a priority of one application 212 is calculated even when the application 212 executes a plurality of files at the same time. The priority may be calculated for each application name and file name. The selected time field stores a time slot during which the respective applications 212 are selected. Also, the example of FIG. 42 is represented while giving an example in which the VM-ID of the VM 2 is “VM01”, but similarly, histories of the other VMs may also be stored.

When one window W of each application 212 is selected, the OS 211 outputs the application name and the selecting start information to the obtaining unit 178. When the selecting start information is accepted, the obtaining unit 178 stores the application name and the time output from the clock unit 18 as the selecting start time in the history file 154. When another window W of each application 212 is selected, the OS 211 outputs the application name and the selecting end information related to the one window W to the obtaining unit 178. When the selecting end information is accepted, the obtaining unit 178 stores the application name and the time output from the clock unit 18 as the selecting end time in the history file 154. When the selecting start information of the application 212 is accepted, the selecting end time of the application 212 selected thus far may be stored in the history file 154.

The calculating unit 1710 calculates the priority based on the time information related to the use of each application 212 stored in the history file 154, the selection information, and the time output from the clock unit 18 at the time of the activation. The calculating unit 1710 calculates a concurrent time slot encompassing a given period of time before and after the current time which is output from the clock unit 18 at the time of the activation. For example, when the current time is 12 o'clock, and the given period of time is 5 minutes, the concurrent time slot is from 11:55 to 12:05. This given period of time may be set as an appropriate value by using the computer 3. According to the present embodiment, the description is given while using 5 minutes as an example. The given period of time may be varied in accordance with times before and after the current time. For example, the given period of time is set as 3 minutes before the current time and 5 minutes after the current time. In this case, the concurrent time slot is from 11:57 to 12:05.

The calculating unit 1710 refers to the history file 154 and counts the number of selected times of the application 212 selected in the concurrent time slot. As depicted by the underlined times in the example of FIG. 42, the number of selected times for the application name “A” is 2, and the number of selected times for the application name “D” is 1. In this case, the calculating unit 1710 assigns the priority in accordance with the number of selected times. For example, the priority 2 is calculated for the application name “A”, and the priority 1 is calculated for the application name “D”. For the calculation of the priority, the calculating unit 1710 may assign a weight in accordance with a difference between the current time and the suspending time. In this case, the calculating unit 1710 may multiply the number of selected times by a weight which becomes larger as the difference between the current time and the suspending time is smaller.

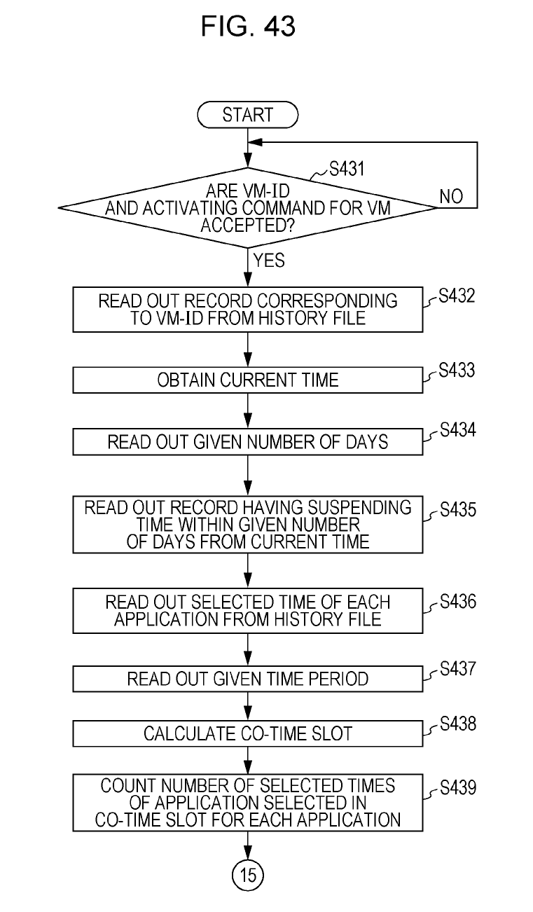

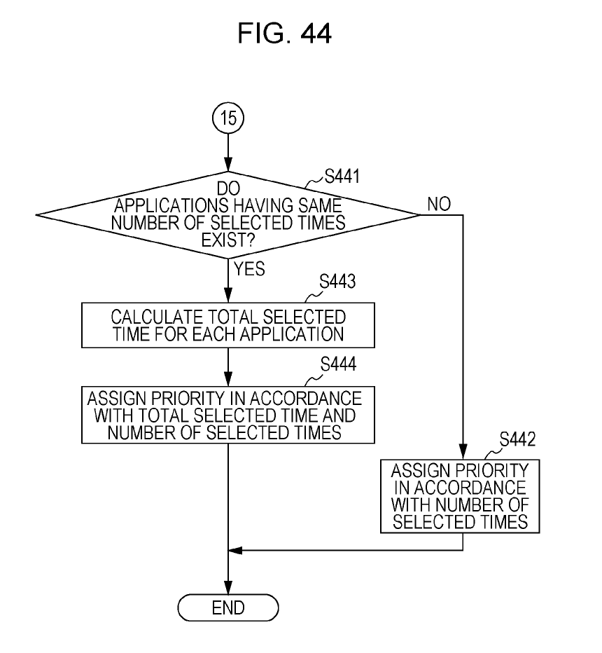

FIGS. 43 and 44 are operation charts representing examples of a procedure of the priority calculation processing according to Embodiment 10. The activating unit 179 determines whether or not the activating target VM-ID and the activating command for the VM 2 are accepted from the computer 3 (at operation S431). When it is determined that the activating target VM-ID and the activating command are not accepted (at operation S431: NO), the activating unit 179 stands by until the acceptance. On the other hand, when it is determined that the activating command is accepted (at operation S431: YES), the activating unit 179 outputs the activating command to the calculating unit 1710.

The calculating unit 1710 reads out the record corresponding to the VM-ID accepted in operation S431 from the history file 154 (at operation S432). The calculating unit 1710 obtains the current time from the clock unit 18 (at operation S433). The calculating unit 1710 reads out a given number of days from the HD 15 (at operation S434). The given number of days may be appropriately changed by using the computer 3, and for example, 7 days may be set. The calculating unit 1710 reads out records having a suspending time within the read out given number of days as viewed from the current time from the history file 154 (at operation S435). The description will be provided while giving an example in which the given number of days is read out in operation S434, and only the records within the given number of days are processed, but the configuration is not limited to the above. All the records may be processed.

The calculating unit 1710 reads out the selected times of the respective applications 212 from the read out records of the history file 154 (at operation S436). The calculating unit 1710 reads out a given time period previously stored in the HD 15 (at operation S437). Based on the read out given time period and the current time, the calculating unit 1710 calculates a concurrent time slot (at operation S438). The calculating unit 1710 counts the number of selected times of the application 212 selected in the concurrent time slot for each application 212 (at operation S439).

The calculating unit 1710 determines whether or not applications having the same number of selected times exist (at operation S441). When it is determined that applications having the same number of selected times do not exist (at operation S441: NO), the calculating unit 1710 assigns the priority in accordance with the number of selected times (at operation S442). On the other hand, when it is determined that applications having the same number of selected times do exist (at operation S441: YES), the calculating unit 1710 calculates a total selected time for each application 212 (at operation S443). The calculation of the total selected time for each application 212 is carried out based on the selecting start time and the selecting end time stored in the selected time field of the history file 154.

The calculating unit 1710 assigns the priority in accordance with the total selected time and the number of selected times (at operation S444). When the numbers of selected times are not the same, for each application 212, a higher priority is assigned as the number of selected times is larger. Also, with regard to the application 212 having the same number of selected times, a higher priority is assigned as the total selected time is longer. According to this, it is possible to appropriately resume the applications 212 in accordance with the use situation of the applications 212 by the user using the VM 2.

This Embodiment 10 is as described above. Other components are similar to Embodiments 1 to 9. Thus, the corresponding parts are denoted by the same reference symbols, and a detailed description thereof is omitted.

### Embodiment 11

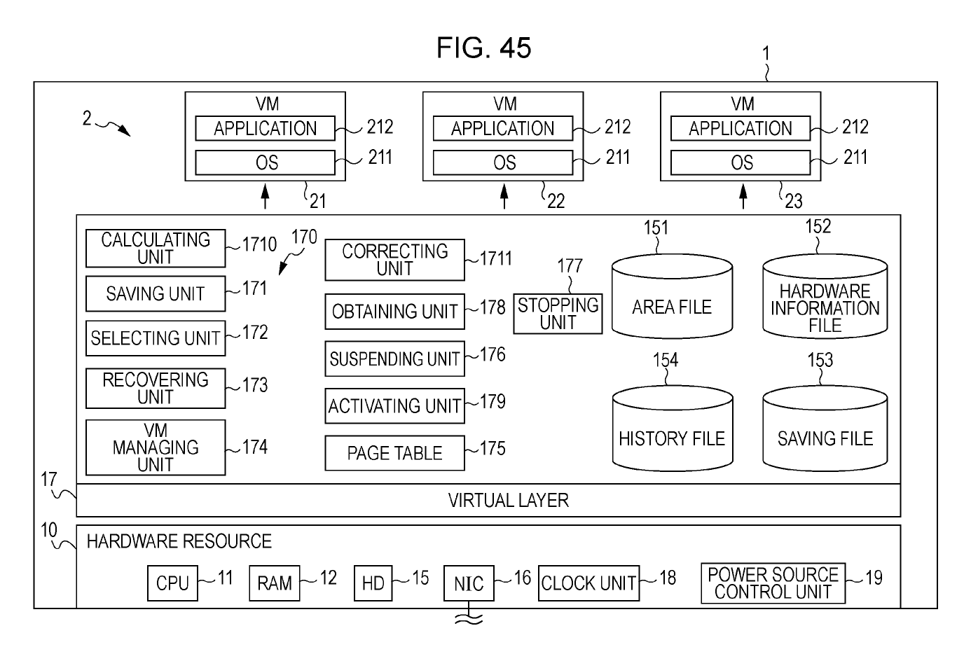

Embodiment 11 relates to a mode in which an operation with respect to the window W related to the application 212 resumed after the activation is accepted, the priority is corrected. FIG. 45 is a block diagram depicting an example of hardware and software of the physical machine 1 and the VM 2 according to Embodiment 11. According to Embodiment 11, a correcting unit 1711 is further provided as the control module 170. The correcting unit 1711 sets a flag with respect to the application 212 where an operation is performed on the window W for the first time within a given time after the resuming of the application 212 by the resuming unit 173. Then, when the calculating unit 1710 calculates the priority at the time of suspending or activation afterwards, the priority of the application 212 where the flag is set is corrected. According to the present embodiment, as an example, a processing of calculating the priority at the time of the activation afterwards and correcting the calculated priority will be described.

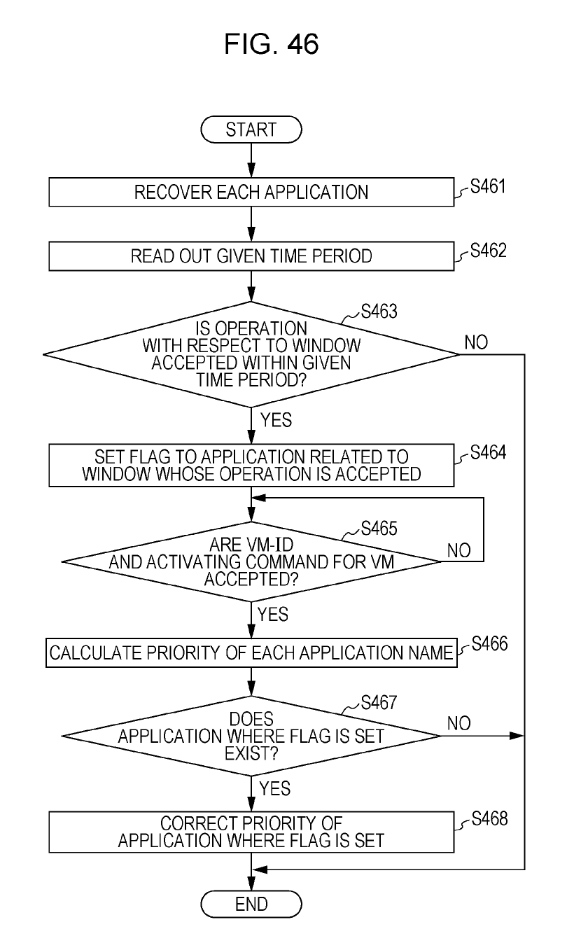

FIG. 46 is an operation chart representing examples of a procedure of the correction processing. As in the embodiments described so far, the respective applications 212 are similarly resumed (at operation S461). The OS 211 of the VM 2 outputs the window W to the NIC 16. On the display unit of the computer 3, the windows W of the respective applications 212 are displayed. The resuming unit 173 outputs a resuming command to the correcting unit 1711. When the resuming command is accepted, the correcting unit 1711 reads out a given time period stored in the HD 15 (at operation S462). This given time may be appropriately changed by using the computer 3. For example, 5 minutes may be stored. Concurrently, the resuming unit 173 resumes the remaining applications 212. The user operates the window W through an input unit of the computer 3. This operation is relevant, for example, to a selection switching of the windows W, an input of characters, a file operation, or the like. Information based on the operation is output from the computer 3 via the NIC 16 to the OS 211. The OS 211 outputs information indicating that the operation is performed to the correcting unit 1711.

The correcting unit 1711 determines whether or not the operation with respect to the window W is accepted within the given time period (at operation S463). When it is determined that the operation with respect to the window W is not received (in operation S463: NO), the correcting unit 1711 does not perform the correction, and the processing is ended. On the other hand, when it is determined that the operation with respect to the window W is accepted (at operation S463: YES), the correcting unit 1711 sets a flag for the application 212 related to the window W accepting the operation (at operation S464). This flag may be stored in the history file 154 in association with the application 212.

Thereafter, the VM 2 is suspended and then activated again due to the activating command. The activating unit 179 determines whether or not the activating target VM-ID and the activating command for the VM 2 are accepted from the computer 3 (at operation S465). When it is determined that the activating target VM-ID and the activating command are not accepted (at operation S465: NO), the activating unit 179 stands by until the acceptance. On the other hand, when it is determined that the activating command is accepted (at operation S465: YES), the activating unit 179 outputs the activating command to the calculating unit 1710 and the correcting unit 1711. While following the above-mentioned various algorithms, the calculating unit 1710 calculates the priority (at operation S466).

When the activating command is accepted, the correcting unit 1711 refers to the history file 154 to determine whether or not the application 212 in which the flag is set exists among the applications 212 whose priority is calculated (at operation S467). When it is determined that the flag is not set (at operation S467: NO), the correcting unit 1711 does not perform the correction, and the processing is ended. On the other hand, when it is determined that the flag is set (at operation S467: YES), the correcting unit 1711 corrects the priority of the application 212 in which the flag is set (at operation S468). For example, the priority correction may be set as a processing of increasing the priority through multiplication with a coefficient larger than 1, addition of a positive value, or the like.

The correcting unit 1711 outputs the priority after the correction to the calculating unit 1710. The calculating unit 1710 outputs the priority after the correction to the selecting unit 172. The selecting unit 172 selects the application 212 to be preferentially resumed based on the priority after the correction. In addition, a flag number may be stored for each application 212. In operation S464, the flag number is incremented. Also, in operation S463, the flag number is decremented for the application 212 where the operation with respect to the window W does not exist. The minimum value for the flag number may be set as 1. Then, the correcting unit 1711 may multiply the priority calculated in operation S466 by the counted flag number. Accordingly, the application 212 having a high use frequency by the user may also be preferentially resumed after the time of the activation, and it is possible to improve the operation efficiency.

This Embodiment 11 is as described above. Other components are similar to Embodiments 1 to 10. Thus, the corresponding parts are denoted by the same reference symbols, and a detailed description thereof is omitted.

### Embodiment 12

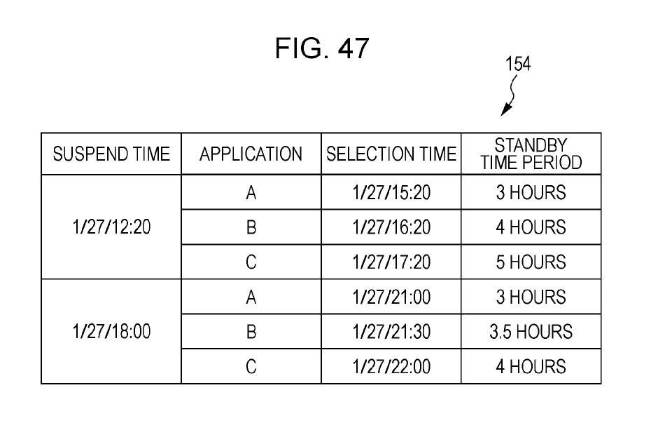

Embodiment 12 relates to a mode in which the priority is corrected based on standby time periods of the respective applications 212 and the suspending time period of the VM 2. FIG. 47 is an explanatory diagram representing an example of a record layout of the history file 154 according to Embodiment 12. The history file 154 includes the suspending time field, the application field, the selected time field, the standby time period field, and the like. The suspending time field stores the time when the VM 2 is suspended. When the suspending command for the VM 2 is accepted, the obtaining unit 178 stores the time output from the clock unit 18 as the suspending time in association with the VM-ID. Furthermore, the obtaining unit 178 obtains the name of the application executed at the time of suspended state from the OS 211 to be stored in the history file 154.

The selected time field stores a time when the operation with respect to the window W related to the application 212 is accepted after the obtaining unit 178 accepts the activating command for the VM 2 again. When the operation with respect to the window W related to the application 212 is accepted from the computer 3, the OS 211 outputs the application name to the obtaining unit 178. The obtaining unit 178 stores the time output from the clock unit 18 as the selected time with respect to the window W related to the application 212 in the history file 154. The standby time period field stores a time period from the previous suspending time for the VM 2 to the selected time when the window W of the application 212 is selected afterwards as the standby time period.

The obtaining unit 178 stores the standby time period calculated based on the difference between the selected time and the suspending time for each application 212. For example, the VM 2 is suspended at 12:20 on January 27, and thereafter, the VM 2 is activated. At that time, the window W of the application name “A” is operated at 15:20 on January 27, and the suspending time period is 3 hours. The example of FIG. 47 is represented while giving an example in which the VM-ID is “VM01”, but information on the other VM 2 is also similarly stored.

The correcting unit 1711 reads out the standby time periods of the respective applications 212 stored in the history file 154 and calculates an average standby time period. Also, the correcting unit 1711 reads out the previous suspending time from the history file 154 at the time of the activation. The correcting unit 1711 obtains the current time (the activating time) output from the clock unit 18 at the time of the activation. Then, the correcting unit 1711 obtains the suspending time period of the VM 2 by calculating a difference between the current time and the suspending time. For each application 212, the correcting unit 1711 calculates the difference between this suspending time period of the VM 2 and the average standby time period calculated for each application 212. Then, for each application 212, the correcting unit 1711 assigns a weight which becomes larger as the calculated difference is smaller. For example, when the difference is 1 hour, the weight may be set as 10, and when the difference is 2 hours, the weight may be set as 9. Also, the minimum value of the weight may be set as 1. The correcting unit 1711 corrects the priority by multiplying the priority calculated by the calculating unit 1710 by the weight. When the flag set in the application 212 as described in Embodiment 11 exists, a correction processing based on the relevant flag may also be executed as well.

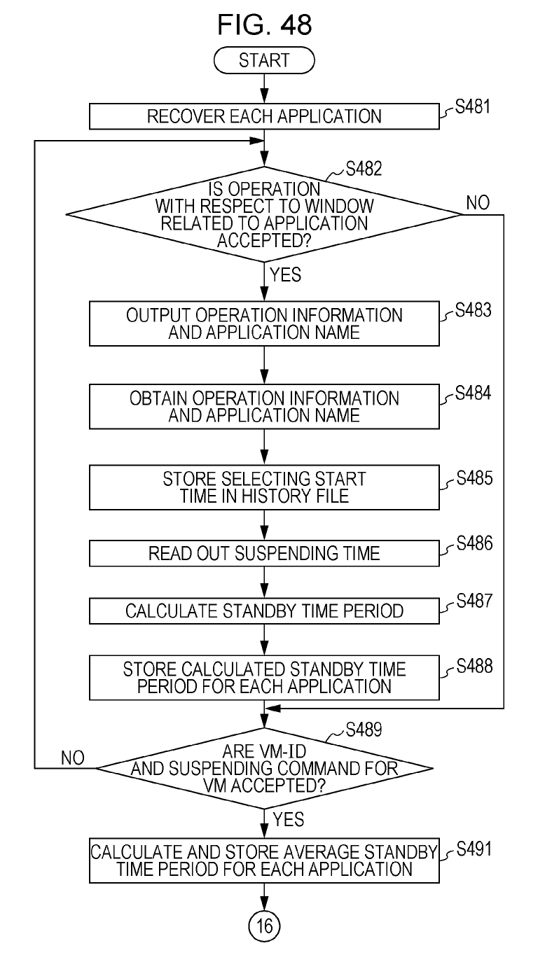

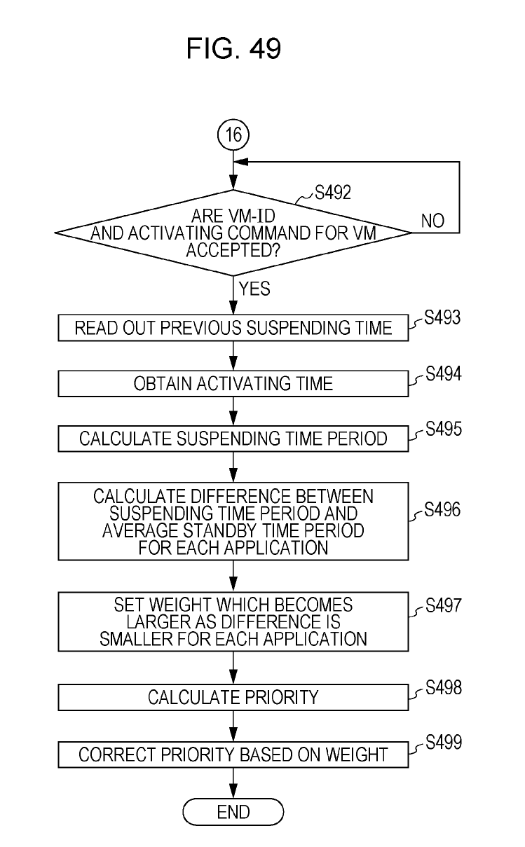

FIGS. 48 and 49 are operation charts representing examples of depicting a procedure of a priority calculation processing according to Embodiment 12. The resuming unit 173 resumes the application 212 in the use area of the RAM 12 through the above-mentioned processing (at operation S481). The OS 211 determines whether or not the operation with respect to the window W related to the application 212 is accepted from the computer 3 (at operation S482). When the operation with respect to the application 212 is accepted (at operation S482: YES), the OS 211 outputs information indicating that the operation is performed (hereinafter, which will be referred to as “operation information”) and the application name to the obtaining unit 178 (at operation S483). The obtaining unit 178 obtains the operation information and the application name (at operation S484).

The obtaining unit 178 refers to the output from the clock unit 18 and stores the selecting start time of the window W in the history file 154 (at operation S485). The correcting unit 1711 refers to the history file 154 and reads out the suspending time upon the previous suspending of the VM 2 (at operation S486). The correcting unit 1711 calculates the standby time period from the suspending time to the selecting start time stored in operation S485 (at operation S487). The correcting unit 1711 stores the calculated standby time period in the history file 154 for each application 212 (at operation S488).

After operation S488 or when the OS 211 determines that the operation with respect to the window W related to the application 212 is not accepted (at operation S482: NO), the operation is shifted to operation S489. The suspending unit 176 determines whether or not the suspending target VM-ID and the suspending command for the VM 2 are accepted from the computer 3 (at operation S489). When the suspending unit 176 determines that the suspending target VM-ID and the suspending command are not accepted (at operation S489: NO), the operation is shifted to operation S482, and the standby time period is also similarly calculated for the other application 212.

When the VM-ID and the suspending command are accepted (at operation S489: YES), the suspending unit 176 outputs the suspending command to the correcting unit 1711. The correcting unit 1711 reads out the standby time periods of the respective applications 212 of the history file 154 for a given number of days (for example, 30 days). Then, the average standby time period is calculated for each application 212, and the calculated average standby time period is stored in the HD 15 (at operation S491). The suspending unit 176 puts the VM 2 in the suspended state. Accordingly, at the time of suspended state, the average standby time period for each application 212 is stored in the HD 15 based on the past use history.

Subsequently, a description will be given of a procedure for a processing when the activating command for the VM 2 is accepted from the computer 3. The activating unit 179 determines whether or not the activating target VM-ID and the activating command for the VM 2 are accepted from the computer 3 (at operation S492). When it is determined that the activating target VM-ID and the activating command are not accepted (at operation S492: NO), the activating unit 179 stands by until the acceptance. On the other hand, when it is determined that the activating command is accepted (at operation S492: YES), the activating unit 179 outputs the activating command to the correcting unit 1711. The correcting unit 1711 reads out the previous suspending time from the history file 154 (at operation S493). This suspending time may be set as the time output from the clock unit 18 when the suspending command is accepted in operation S489.

The correcting unit 1711 refers to the time output from the clock unit 18 and obtains the activating time (at operation S494). The correcting unit 1711 calculates the suspending time period from the suspending time upon the previous suspending read out in operation S493 to the activating time of the VM 2 (at operation S495). The correcting unit 1711 calculates a difference between the calculated suspending time period and the calculated average standby time period of the respective applications 212 for each application 212 (at operation S496). The correcting unit 1711 set a weight which becomes larger as the calculated difference is smaller for each application 212 (at operation S497).

The calculating unit 1710 calculates the priorities of the respective applications 212 through the above-mentioned processing (at operation S498). The correcting unit 1711 corrects the priorities of the respective applications 212 based on the set weights of the respective applications 212 (at operation S499). Accordingly, the priority is optimized in accordance with the use past record by the user, and it is possible to further improve the use of the application 212 at the time of the activation.

This Embodiment 12 is as described above. Other components are similar to Embodiments 1 to 11. Thus, the corresponding parts are denoted by the same reference symbols, and a detailed description thereof is omitted.

### Embodiment 13

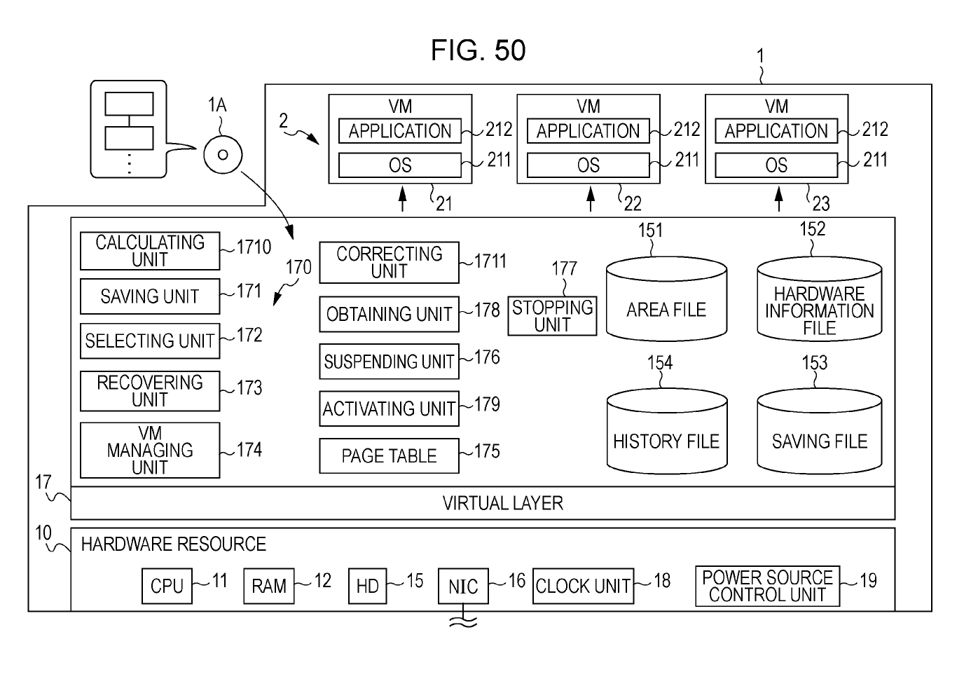

FIG. 50 is a block diagram depicting an example of hardware and software of the physical machine 1 and the VM 2 according to Embodiment 13. A program for operating the physical machine 1 according to Embodiments 1 to 12 may be stored in the HD 15 as in this Embodiment 13 while a reading unit (not shown) reads a portable recording medium 1A such as a CD-ROM or a DVD-ROM. Also, the program may also be downloaded from another server computer (not shown) connected via a communication network such as the internet. Contents thereof will be described below.

The physical machine 1 depicted FIG. 50 downloads the program for storing the use area to save the information and the like from another server computer (not shown) by the portable recording medium 1A or via the communication network. The program is installed as the control module 170 to be loaded onto the RAM 12 for execution. With the configuration in FIG. 50, this program functions as the physical machine 1.

This Embodiment 13 is as described above. Other components are similar to Embodiments 1 to 12. Thus, the corresponding parts are denoted by the same reference symbols, and a detailed description thereof is omitted.

Further, according to an aspect of the embodiments, any combinations of the described features, functions and/or operations may be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. A computer-readable recording medium storing a program for causing a computer to function as a virtual machine control apparatus, the program causing the computer to execute:
storing, in association with a virtual machine in operation subject to a suspending command, information in a memory used by application programs, in a storage unit, when the suspending command for the virtual machine is accepted; and
selecting an application program to be preferentially resumed from among the application programs stored in the storage unit to a memory use area of the memory, based on the information in the memory used by the application program stored in association with the virtual machine subject to an activating command, when the activating command for the virtual machine is accepted.

2. The program according to claim 1, further comprising:
storing information related to a memory use area used by an application program operating on a virtual machine; and
restoring the information in the memory stored in the storage unit used by the application program selected in the selecting, to a memory use area to be specified based on the information related to the use area stored in the storage unit.

3. The program according to claim 2, wherein
the storing includes storing identification information for specifying an application program and a memory use area used by an application program, in association with each other, and
the selecting includes
outputting a selection item corresponding to the identification information stored in the storing, when an activating command for a virtual machine is accepted;
accepting an input operation corresponding to the output selection item based on the identification information, and
selecting an application program related to identification information corresponding to a selection item that receives an input operation, among the application programs.

4. The program according to claim 2, further comprising:
obtaining a memory use area used by an application program operating on a virtual machine and history information related to a use of the application program, wherein
the storing includes storing respective memory use areas used by a plurality of application programs obtained in the obtaining, and the history information, in association with the identification information for specifying the application program.

5. The program according to claim 4, wherein
the selecting includes selecting, from among the plurality of application programs, an application program to be preferentially resumed from the storage unit to the memory use area, based on the identification information stored in the storing, when an activating command for a virtual machine is accepted.

6. The program according to claim 5, wherein
the obtaining further includes
obtaining a memory use area used by an application program operating on a virtual machine, and
referring to time information output from a clock unit and obtaining time information related to the use of the application program as history information;
and wherein
the selecting includes selecting, from among the plurality of application programs, an application program to be preferentially resumed from the storage unit to the memory use area, based on time information output by a clock unit and time information related to the use stored in the storing, when an activating command for a virtual machine that is suspended is accepted.

7. The program according to claim 6, wherein
the selecting further includes
reading out use start times of the respective application programs stored in the storing,
calculating a difference between the read out use start times of the respective application programs and a current time output from the clock unit, for each application program, and
selecting an application program whose the calculated difference is small.

8. The program according to claim 5, wherein
the obtaining further includes
obtaining a memory use area used by an application program operating on a virtual machine, and
referring to time information output from a clock unit, and obtaining the time information related to the use of the application program and selection information indicating whether or not a window related to the application program is selected, as the history information, and
the selecting includes selecting, from among the plurality of application programs, an application program to be preferentially resumed from the storage unit to the memory use area, based on time information related to the use stored in the storing and the selected application program, when an activating command for a virtual machine that is suspended is accepted.

9. The program according to claim 8, the program wherein
the selecting further includes
referring to the time information related to the use stored in the storing and the selection information, and calculating a total time period of time periods during which windows related to respective application programs are selected, for respective application programs, and
selecting an application program having a long total time period among the plurality of application programs.

10. The program according to claim 5, wherein
the obtaining further includes
obtaining a memory use area used by an application program operating on a virtual machine, and
referring to time information output from a clock unit and obtaining time information related to a use of the application program and selection information indicating whether or not a window related to the application program is selected, as the history information, and
the selecting includes selecting, from among the plurality of application programs, an application program to be preferentially resumed from the storage unit to the memory use area, based on time information related to the use stored in the storing, selection information, and time information output from a clock unit, when an activating command for a virtual machine that is suspended is accepted.

11. The computer-readable recording medium storing the program according to claim 10, the program wherein
the selecting further includes
referring to the time information and the selection information related to the use stored in the storing, and extracting selected times at which a window related to respective application programs are selected, for respective application programs, and
selecting an application program in which a current time output from a clock unit belongs to the extracted selected time.

12. The computer-readable recording medium storing the program according to claim 5, the program wherein
the obtaining includes obtaining the information on a memory use area used by an application program operating on a virtual machine, and selection information indicating whether or not a window related to the application program is selected, as history information, and
the storing includes storing the respective memory use areas used by the plurality of application programs obtained in the obtaining, and the selection information on the respective application programs, as history information, and
the selecting further includes
referring to the selected information on the respective application programs stored in the storing, and counting the number of times each application program is selected, and
selecting an application program whose counted number is large.

13. The program according to claim 4, further comprising:
calculating a priority for each application program based on the history information stored in the storing, wherein
the selecting further includes
outputting items of identification information related to each of the plurality of application programs stored in the storing in accordance with the calculated priority, when an activating command for a virtual machine that is suspended in accepted,
accepting an input of identification information selected from the output items of identification information, and
selecting an application program related to the identification information whose input is accepted, among the plurality of application programs.

14. The program according to claim 13, further comprising:
reading out memory use areas used by an application program corresponding to the identification information stored in the storing, when the input identification information is accepted in the accepting;
calculating a total value of the read out memory use areas; and
outputting warning information when the calculated total value of the memory use areas exceeds a given threshold.

15. The program according to claim 4, further comprising:
calculating a priority for each application program based on the history information stored in the storing, wherein
the selecting includes selecting, from among the plurality of application programs, an application program to be preferentially resumed from the storage unit to the memory use area, based on the calculated priority, when an activating command for a virtual machine that is suspended is accepted.

16. The program according to claim 15, further comprising:
reading out the memory use area used by the application program stored in the storing;
calculating the total value by sequentially adding the use area of an application program having a low priority to the use area of the application program having the highest priority calculated in the priority calculating according to a priority level; and
cancelling, when the calculated total value of the use areas exceeds a given threshold, adding a use area of an application program related to the priority at the time of exceeding the given threshold, wherein
the selecting includes selecting, from among the plurality of application programs, application programs from the application with the highest priority to the application program that has a priority higher than the priority at the time of exceeding the given threshold, when an activating command for a virtual machine that is suspended is accepted.

17. The program according to claim 13, wherein
the obtaining further includes
obtaining a memory use area used by an application program operating on a virtual machine, and
referring to time information output from a clock unit, and obtaining time information related to a use of an application program, as history information, wherein
the calculating includes calculating the priority based on time information related to a use of the respective application programs stored in the storing, and time information output from a clock unit.

18. The program according to claim 17, wherein
the calculating further includes
calculating a difference between a use start time of each application program stored in the storing and a current time output from the clock unit, for each application program, and
assigning a higher priority in ascending order of the calculated difference.

19. A virtual machine control apparatus that controls operations of a plurality of virtual machines, the virtual machine control apparatus comprising:
a saving part that saves information on a memory used by an application program in a storage unit different from the memory, in association with a virtual machine subject to a suspending command, when the suspending command for the virtual machine in operation; and
a selecting part that selects an application program to be preferentially resumed from the storage unit to the memory use area, based on the information in the memory used by the application program which is stored in association with the virtual machine subject to the activating command, when the activating command for the virtual machine is accepted.

20. A method for making a program cause a computer to function as a virtual machine control apparatus, the program causing the computer to execute:
saving information on a memory used by an application program, in an storage unit in association with a virtual machine subject to a suspending command, when the suspending command for the virtual machine is accepted; and
selecting, an application program to be preferentially resumed from the storage unit to a use area of the memory based on the information in the memory used by the application program which is stored in association with the virtual machine subject to a activating command, when the activating command for the virtual machine is accepted.
